(19) United States
(12) Patent Application Publication
(10) Pub. No.: US 2005/0158093 A1
(43) Pub. Date: Jul. 21, 2005

(54) Image forming apparatus in which recording sheet having tab is used

(75) Inventors: Kenji Kato, Tokyo (JP); Hiroyuki Watanabe, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA BUSINESS TECHNOLOGIES, INC., Tokyo (JP)

(21) Appl. No.: 10/981,208

(22) Filed: Nov. 3, 2004

(30) Foreign Application Priority Data
Jan. 15, 2004 (JP) JP2004-007803

(51) Int. Cl. G03G 15/00

(52) U.S. Cl. 399/388

(57) ABSTRACT

An image forming apparatus includes: a feeding section for feeding sheets with tabs and sheets without tabs; a tab detecting section for detecting the end position, in the sheet conveyance direction, of tabs on the sheets fed by the feeding section; a conveying section for conveying sheets that are sequentially fed by the feeding section; and a control section for controlling the conveying section in such as way as to keep constant an interval between a trailing edge of a preceding sheet in the sheet conveyance direction and a leading edge of a succeeding sheet, based on the results of tab detection by the tab detecting section.

### BACKGROUND OF THE INVENTION

The present invention relates to an image forming apparatus such as copying machines or printers, particularly to an image forming apparatus that is able to print on sheets with tabs.

There have been cases where sheets with tabs were used with various types of image forming apparatus such as copying machines or printers.

FIG. 15 is an explanatory drawing showing sheets with tabs. Seven sheets of paper are shown in this drawing, and the third sheet from the top (X in FIG. 15) and the fifth sheet from the top (Y in FIG. 15) are “sheets with tabs.”

In FIG. 15, the portion x protruding from the third sheet from the top (X in FIG. 15) is the tab, and also, the portion y protruding from the fifth sheet from the top (Y in FIG. 15) is the tab. In FIG. 16, L stands for the tab length, and W stands for the tab width. Also in FIG. 15, although positions of the tabs x and y differ from each other in terms of the length-wise direction of the sheets, these positions are the specified tab positions.

FIG. 17(a) through FIG. 17(d) are explanatory drawings each showing an example tab type. Tabs shown in FIG. 17(a) have the same width but different lengths (Type A), and the side of the sheet provided with a tab is divided into 3 (3 tabs). In other words, the division number in this case is 3.

Tabs shown in FIG. 17(b) have the same width but different lengths (Type A), and the side of, the sheet provided with a tab is divided into 4 (4 tabs). In other words, the division number in this case is 4.

Tabs shown in FIG. 17(c) have the same width and length, but the positions in which they are provided (tab position) differ from each other (Type B), and the side of the sheet provided with a tab is divided into 3 (3 tabs). In other words, the division number in this case is 3.

Tabs shown in FIG. 17(d) have the same width and length, but the positions that they are provided (tab position) differ from each other (Type B), and the side of the sheet provided with a tab is divided into 4 (4 tabs). In other words, the division number in this case is 4.

Since tab positions, tab lengths, and tab widths were different even for the tabs of the same type having the division numbers mentioned above, conventional image forming apparatuses were not configured to detect tab positions.

Also, sheets had to be set in the paper feed cassette with the tabs at correct positions so that the formed images on the tabs would not run off the edge. Furthermore, the finished images could only be checked after the images were actually formed on the tabs.

Also, sheets with tabs were usually inserted between other sheets of paper, and their tabs thus had to be arranged in the correct order for insertion when they were set in the paper feed cassette. In other words, when the order of the tabs was incorrectly arranged, sheets with tabs at the desired positions were not appropriately inserted.

Furthermore, due to different tab positions, lengths, and widths, if the tab was located at the leading edge of the sheet in the sheet conveyance direction in the prior art image forming apparatus, the sheet was skewed when the tab came in contact with the registration roller and others, and sheet control was difficult, with the result that images could be formed only at the rear end of the sheet in the sheet conveyance direction. Therefore, it was not possible to form images on both sides of the sheet when the sheet had a tab.

Moreover, since tab widths and tab lengths were not detected or controlled, when the interval between conveyed sheets was small or when a slip occurred inside image forming apparatuses, there was a possibility that sheets with tabs and other types of paper would collide.

Note that a paper movement timing control for an image forming apparatus compatible with this type of sheets with tabs has been proposed in the Patent Document 1 representing Official Gazette of Japanese Patent Tokkaihei 8-245003.

In the abovementioned Patent Document 1, sheets with tabs and regular sheets (sheets of paper other than sheets with tabs (sheets without tabs)) are fed and conveyed with intervals in between, and these intervals are calculated based on the order arrangement of sheets with tabs and sheets without tabs.

However, this method has a problem in that, when a type of sheets with tabs that is not planned to be fed is actually fed, then image forming apparatuses are not able to appropriately conduct paper conveyance or image forming operation.

As a result, image processing apparatuses in fact provided some extra room to be added to the already provided intervals before and after a sheet with a tab. For this reason, image forming apparatuses were not able to maximize its capability (productivity (the number of sheets that went through the apparatus per unit time)) when they used sheets with tabs.

### SUMMARY OF THE INVENTION

In view of the prior art described above, it is an object of the present invention to achieve the following objects.

The first object of the present invention is to provide an image forming apparatus capable of ensuring the maximum productivity when a sheet with a tab is used.

The second object of the present invention is to provide an image forming apparatus capable of preventing an unintended image from being formed or an image from being formed out of the sheet when a sheet with a tab is used.

The third object of the present invention is to provide an image forming apparatus ensuring an intended image to be formed when a sheet with a tab is used.

The aforementioned objects can be achieved by any one of the following Structures (1) through (23):

(1) An image forming apparatus comprising: a feeding section for feeding sheets with tabs as well as sheets without tabs; a tab detecting section for detecting the end position, in the sheet conveyance direction, of tabs on the sheets fed by the aforementioned feeding section; a conveying section for conveying sheets that are sequentially fed by the aforementioned feeding section; and a control section for controlling the aforementioned conveying section in such as way as to keep constant the interval between the trailing edge of a preceding sheet in the sheet conveyance direction and the leading edge of a succeeding sheet, based on the results of tab detection by the aforementioned tab detecting section.

This image forming apparatus detects the trailing edge of the tab in the sheet conveyance direction after the sheet has been fed and controls the conveyance of the sheet in such as way as to keep constant the interval between the trailing edge of a sheet in the sheet conveyance direction and the leading edge of a succeeding sheet in the sheet conveyance direction, based on the result of this detection.

(2) The image forming apparatus as described in the Structure (1), wherein the aforementioned tab detecting section detects whether tabs are located at the leading edge or the trailing edge of the sheet in the sheet conveyance direction.

The image forming apparatus detects the edge of the tab in the sheet conveyance direction after the sheet has been fed. It also detects whether the tab is located at the leading edge or the trailing edge in the conveyance direction. Based on the results of these detections, the image forming apparatus controls the conveyance of the sheet in such as way as to keep constant the interval between the trailing edge of a sheet in the sheet conveyance direction and the leading edge of the succeeding sheet in the sheet conveyance direction.

(3) The image forming apparatus as described in one of the Structures (1) and (2), wherein the aforementioned tab detecting section detects the position of the aforementioned tab in the direction orthogonal to the aforementioned sheet conveyance direction.

This image forming apparatus detects the edge of the tab in the sheet conveyance direction after the sheet has been fed. It also detects the position of the tab in the direction orthogonal to the sheet conveyance direction. Based on the results of these detections, the sheet conveyance is controlled in such as way as to keep constant the interval between the trailing edge of a sheet in the sheet conveyance direction and the leading edge of the succeeding sheet in the sheet conveyance direction.

Further, this image forming apparatus detects the edge of the tab in the sheet conveyance direction after the sheet has been fed. It also detects whether the tab is located at the leading edge or the trailing edge in the conveyance direction. It further detects the position of the aforementioned tab in the direction orthogonal to the aforementioned sheet conveyance direction. Based on the results of these detections, the sheet conveyance is controlled in such as way as to keep constant the interval between the trailing edge of a sheet in the sheet conveyance direction and the leading edge of the succeeding sheet in the sheet conveyance direction.

(4) The image forming apparatus as described in any one of the Structures (1) through (3), further provided with an image forming section for forming an image on the aforementioned tab.

This image forming apparatus detects the edge of the tab in the sheet conveyance direction after the sheet has been fed. Based on the result of this detection, the sheet conveyance is controlled in such as way as to keep constant the interval between the trailing edge of a sheet in the sheet conveyance direction and the leading edge of the succeeding sheet in the sheet conveyance direction, and an image is formed on the tab by the image forming section.

This image forming apparatus detects the edge of the tab in the sheet conveyance direction after the sheet has been fed. It also detects whether the tab is located at the leading edge or the trailing edge in the conveyance direction. Based on the results of these detections, the sheet conveyance is controlled in such as way as to keep constant the interval between the trailing edge of a sheet in the sheet conveyance direction and the leading edge of the succeeding sheet in the sheet conveyance direction, and an image is formed on the tab by the image forming section.

This image forming apparatus detects the edge of the tab in the sheet conveyance direction after the sheet has been fed. It also detects the position of the tab in the direction orthogonal to the sheet conveyance direction. Based on the results of these detections, the sheet conveyance is controlled in such as way as to keep constant the interval between the trailing edge of a sheet in the sheet conveyance direction and the leading edge of the succeeding sheet in the sheet conveyance direction, and an image is formed on the tab by the image forming section.

This image forming apparatus detects the edge of the tab in the sheet conveyance direction after the sheet has been fed. It also detects whether the tab is located at the leading edge or the trailing edge in the conveyance direction. It also detects the position of the tab in the direction orthogonal to the sheet conveyance direction. Based on the results of these detections, the sheet conveyance is controlled in such as way as to keep constant the interval between the trailing edge of a sheet in the sheet conveyance direction and the leading edge of the succeeding sheet in the sheet conveyance direction, and an image is formed on the tab by the image forming section.

(5) The image forming apparatus described in any one of the Structures (1) through (4), further comprising an information input section for inputting information regarding tabs of sheets with tabs, wherein the aforementioned control section controls the aforementioned conveying section in such as way as to keep constant the interval between the trailing edge of a sheet in the sheet conveyance direction and the leading edge of the succeeding sheet in the sheet conveyance direction, based on the results of the aforementioned tab detection and the aforementioned information.

This image forming apparatus detects the edge of the tab in the sheet conveyance direction after the sheet has been fed. Information on the tab is inputted into the information input section. Based on the results of the aforementioned tab detection and the aforementioned information, the sheet conveyance is controlled in such as way as to keep constant the interval between the trailing edge of a sheet in the sheet conveyance direction and the leading edge of the succeeding sheet in the sheet conveyance direction, and an image is formed on the tab by the image forming section.

This image forming apparatus detects the edge of the tab in the sheet conveyance direction after the sheet has been fed. It also detects whether the tab is located at the leading edge or the trailing edge in the conveyance direction. Information on the tab is inputted into the information input section. Based on the results of the aforementioned tab detection and the aforementioned information, the sheet conveyance is controlled in such as way as to keep constant the interval between the trailing edge of a sheet in the sheet conveyance direction and the leading edge of the succeeding sheet in the sheet conveyance direction.

This image forming apparatus detects the edge of the tab in the sheet conveyance direction after the sheet has been fed. It also detects the position of the tab in the direction orthogonal to the sheet conveyance direction. Information on the tab is inputted into the information input section. Based on the results of the aforementioned tab detection and the aforementioned information, the sheet conveyance is controlled in such as way as to keep constant the interval between the trailing edge of a sheet in the sheet conveyance direction and the leading edge of the succeeding sheet in the sheet conveyance direction.

This image forming apparatus detects the edge of the tab in the sheet conveyance direction after the sheet has been fed. It also detects whether the tab is located at the leading edge or the trailing edge in the conveyance direction. It also detects the position of the tab in the direction orthogonal to the sheet conveyance direction. Information on the tab is inputted into the information input section. Based on the results of the aforementioned tab detection and the aforementioned information, the sheet conveyance is controlled in such as way as to keep constant the interval between the trailing edge of a sheet in the sheet conveyance direction and the leading edge of the succeeding sheet in the sheet conveyance direction.

This image forming apparatus detects the edge of the tab in the sheet conveyance direction after the sheet has been fed. Information on the tab is inputted into the information input section. Based on the results of the aforementioned tab detection and the aforementioned information, the sheet conveyance is controlled in such as way as to keep constant the interval between the trailing edge of a sheet in the sheet conveyance direction and the leading edge of the succeeding sheet in the sheet conveyance direction, and an image is formed on the tab by the image forming section.

This image forming apparatus detects the edge of the tab in the sheet conveyance direction after the sheet has been fed. It also detects whether the tab is located at the leading edge or the trailing edge in the conveyance direction. Information on the tab is inputted into the information input section. Based on the results of the aforementioned tab detection and the aforementioned information, the sheet conveyance is controlled in such as way as to keep constant the interval between the trailing edge of a sheet in the sheet conveyance direction and the leading edge of the succeeding sheet in the sheet conveyance direction, and an image is formed on the tab by the image forming section.

This image forming apparatus detects the edge of the tab in the sheet conveyance direction after the sheet has been fed. It also detects the position of the tab in the direction orthogonal to the sheet conveyance direction. Information on the tab is inputted into the information input section. Based on the results of the aforementioned tab detection and the aforementioned information, the sheet conveyance is controlled in such as way as to keep constant the interval between the trailing edge of a sheet in the sheet conveyance direction and the leading edge of the succeeding sheet in the sheet conveyance direction, and an image is formed on the tab by the image forming section.

This image forming apparatus detects the edge of the tab in the sheet conveyance direction after the sheet has been fed. It also detects whether the tab is located at the leading edge or the trailing edge in the conveyance direction. It also detects the position of the tab in the direction orthogonal to the sheet conveyance direction. Information on the tab is inputted into the information input section. Based on the results of the aforementioned tab detection and the aforementioned information, the sheet conveyance is controlled in such as way as to keep constant the interval between the trailing edge of a sheet in the sheet conveyance direction and the leading edge of the succeeding sheet in the sheet conveyance direction, and an image is formed on the tab by the image forming section.

(6) An image forming apparatus comprising: an information input section for inputting information regarding tabs of sheets with tabs; a feeding section for feeding sheets with tabs as well as sheets without tabs; a tab detecting section for detecting the position of a tab on the sheet with a tab; an image forming section for forming an image on the aforementioned tab on the sheet with a tab; and a control section for providing control in such a way as to stop the image forming operation, when an image is to be formed on the tab, and the information on the tab inputted into the information input section fails to agree with the result of detection by the tab detecting section.

The present invention provide control in such a way as to stop the image forming operation, when an image is to be formed on the tab, and the information on the tab inputted into the information input section fails to agree with the position of the tab detected by the tab detecting section.

(7) The image forming apparatus as described in the Structure (6), wherein further characterized by detecting the position of the tab of the sheet fed by the aforementioned feeding section.

The present invention provides control in such a way as to stop the image forming operation, when an image is to be formed on the tab, and the information on the tab inputted into the information input section fails to agree with the position of the tab detected by the tab detecting section.

(8) The image forming apparatus as described in the Structure (7), wherein the tab detecting section detects the position of the tab of the aforementioned sheet before an image is formed on the sheet by the image forming section.

The present invention provides control in such a way as to stop the image forming operation, when an image is to be formed on the tab, and the information on the tab inputted into the information input section fails to agree with the position of the tab, detected by the tab detecting section, of the sheet fed by the feeding section prior to formation of the image.

(9) The image forming apparatus as described in the Structure (7), wherein, by circulating the sheet with an image formed on one side thereof, the image forming section permits the image to be formed also on the other side thereof, and the tab detecting section detects the position of the tab of the sheet before formation of the image on each side of the sheet.

The present invention control in such a way as to stop the image forming operation, when an image is to be formed on the tab, and the information on the tab inputted into the information input section fails to agree with the position of the tab, detected by the tab detecting section, of the sheet fed by the feeding section prior to formation of the image on each side in the step of both-side image formation.

(10) The image forming apparatus described in any one of the Structures (6) through (9), wherein the aforementioned tab detecting section detects the position of the tab in the direction orthogonal to the sheet conveyance direction.

The present invention provides control in such a way as to stop the image forming operation, when an image is to be formed on the tab, and the information on the tab inputted into the information input section fails to agree with the position of the tab in the direction orthogonal to the sheet conveyance direction.

The present invention provides control in such a way as to stop the image forming operation, when an image is to be formed on the tab, and the information on the tab inputted into the information input section fails to agree with the position of the tab in the direction orthogonal to the sheet conveyance direction, detected by the tab detecting section, of the sheet fed by the feeding section.

The present invention provides control in such a way as to stop the image forming operation, when an image is to be formed on the tab, and the information on the tab inputted into the information input section fails to agree with the position of the tab in the direction orthogonal to the sheet conveyance direction, detected by the tab detecting section, of the sheet fed by the feeding section before formation of the image.

The present invention provides control in such a way as to stop the image forming operation, when an image is to be formed on the tab, and the information on the tab inputted into the information input section fails to agree with the position of the tab in the direction orthogonal to the sheet conveyance direction, detected by the tab detecting section, of the sheet fed by the feeding section before formation of the image on each side in the step of both-side image formation.

(11) The image forming apparatus described in any one of the Structures (6) through (9), wherein the aforementioned tab detecting section detects the position of the tab in the direction orthogonal to the sheet conveyance direction.

The present invention provides control in such a way as to stop the image forming operation, when an image is to be formed on the tab, and the information on the tab inputted into the information input section fails to agree with the position of the tab in the sheet conveyance direction detected by the tab detecting section.

The present invention provides control in such a way as to stop the image forming operation, when an image is to be formed on the tab, and the information on the tab inputted into the information input section fails to agree with the position of the tab in the sheet conveyance direction, detected by the tab detecting section, of the sheet fed by the feeding section.

The present invention provides control in such a way as to stop the image forming operation, when an image is to be formed on the tab, and the information on the tab inputted into the information input section fails to agree with the position of the tab in the sheet conveyance direction, detected by the tab detecting section, of the sheet fed by the feeding section before formation of the image.

The present invention provides control in such a way as to stop the image forming operation, when an image is to be formed on the tab, and the information on the tab inputted into the information input section fails to agree with the position of the tab in the sheet conveyance direction, detected by the tab detecting section, of the sheet fed by the feeding section before formation of the image on each side in the step of both-side image formation.

(12) An image forming apparatus comprising: a feeding section for feeding sheets with tabs as well as sheets without tabs; a tab detecting section for detecting the position of a tab on the sheet with a tab; an image forming section for forming an image on the aforementioned tab on the sheet with a tab; and a control section for controlling the image formation timing of the image forming section, based on the result of detection by the tab detecting section and the information on whether the tab is located at the leading edge or the trailing edge of the sheet in the conveyance direction.

When an image can be formed on the tab, the present invention controls the image formation timing of the image forming section, based on the result of detection by the tab detecting section and the input information on whether the tab is located at the leading edge or the trailing edge of the sheet in the conveyance direction.

(13) The image forming apparatus described in the Structure (12), wherein the tab detecting section detects the position of the aforementioned tab in the direction orthogonal to the sheet conveyance direction.

When an image can be formed on the tab, the present invention controls the image formation timing of the image forming section, based on the position of the tab, in the direction orthogonal to the sheet conveyance direction, detected by the tab detecting section and the information on whether the tab is located at the leading edge or the trailing edge of the sheet.

(14) The image forming apparatus described in the Structure (12) or (13), wherein the tab detecting section detects whether the tab is located at the leading edge or the trailing edge of the sheet in the conveyance direction.

When an image can be formed on the tab, the present invention controls the image formation timing of the image forming section, based on the result of detection regarding whether the tab is located at the leading edge or the trailing edge, and the input information on whether the tab is located at the leading edge or the trailing edge.

When an image can be formed on the tab, the present invention controls the image formation timing of the image forming section, based on: the result of detecting the position of the tab in the direction orthogonal to the conveyance direction; the result of detection regarding whether the tab is located at the leading edge or the trailing edge; and the input information on whether the tab is located at the leading edge or the trailing edge.

(15) The image forming apparatus described in any one of the Structures (12) through (14), wherein the aforementioned control section controls the image formation timing in the aforementioned image forming section in such a way that an image is formed on both sides of the sheet including the aforementioned tab in the case of the sheet containing a tab, based on: the result of detection by the aforementioned tab detecting section, and the information on whether the tab is located at the leading edge or the trailing edge of the sheet.

When an image can be formed on the tab, this image forming apparatus controls the image formation timing in such a way that an image is formed on both sides of the sheet including the aforementioned tab in the case of the sheet containing a tab, based on: the result of detection by the aforementioned tab detecting section, and the input information on whether the tab is located at the leading edge or the trailing edge of the sheet.

When an image can be formed on the tab, this image forming apparatus controls the image formation timing in such a way that an image is formed on both sides of the sheet including the aforementioned tab in the case of the sheet containing a tab based on: the position of the tab in the direction orthogonal to the sheet conveyance direction detected by the tab detecting section, and the input information on whether the tab is located at the leading edge or the trailing edge of the sheet.

When an image can be formed on the tab, this image forming apparatus controls the image formation timing in such a way that an image is formed on both sides of the sheet including the aforementioned tab in the case of the sheet containing a tab based on: the result of detection regarding whether the tab is located at the leading edge or the trailing edge, and the input information on whether the tab is located at the leading edge or the trailing edge of the sheet.

When an image can be formed on the tab, this image forming apparatus controls the image formation timing in such a way that an image is formed on both sides of the sheet including the aforementioned tab in the case of the sheet containing a tab based on: the result of detecting the position of the tab in the direction orthogonal to the conveyance direction, the result of detection regarding whether the tab is located at the leading edge or the trailing edge, and the input information on whether the tab is located at the leading edge or the trailing edge.

(16) The image forming apparatus described in any one of the Structures (12) through (15), wherein the aforementioned image formation timing represents the timing for writing an image on the aforementioned sheet.

According to the present invention, when an image can be formed on the tab, the image formation write timing as the image formation timing is controlled based on: the result of detection by the tab detecting section and the input information on whether the tab is located at the leading edge or the trailing edge of the sheet.

According to the present invention, when an image can be formed on the tab, the image formation write timing as the image formation timing is controlled based on: the position of the tab in the direction orthogonal to the sheet conveyance direction detected by the tab detecting section, and the input information on whether the tab is located at the leading edge or the trailing edge of the sheet.

According to the present invention, when an image can be formed on the tab, the image formation write timing as the image formation timing is controlled based on: the result of detection regarding whether the tab is located at the leading edge or the trailing edge, and the input information on whether the tab is located at the leading edge or the trailing edge.

According to the present invention, when an image can be formed on the tab, the image formation write timing as the image formation timing is controlled based on: the result of detecting the position of the tab in the direction orthogonal to the conveyance direction, the result of detection regarding whether the tab is located at the leading edge or the trailing edge, and the input information on whether the tab is located at the leading edge or the trailing edge.

According to the present invention, when an image can be formed on the tab, the image formation write timing as the image formation timing is controlled in such a way that an image is formed on both sides of the sheet including the aforementioned tab in the case of the sheet containing a tab based on: the result of detection by the tab detecting section, and the input information on whether the tab is located at the leading edge or the trailing edge of the sheet.

According to the present invention, when an image can be formed on the tab, the image formation write timing as the image formation timing is controlled in such a way that an image is formed on both sides of the sheet including the aforementioned tab in the case of the sheet containing a tab based on: the result of detecting the position of the tab in the direction orthogonal to the conveyance direction detected by the tab detecting section, and the input information on whether the tab is located at the leading edge or the trailing edge of the sheet.

According to the present invention, when an image can be formed on the tab, the image formation write timing as the image formation timing is controlled in such a way that an image is formed on both sides of the sheet including the aforementioned tab in the case of the sheet containing a tab based on: the result of detection regarding whether the tab is located at the leading edge or the trailing edge, and the input information on whether the tab is located at the leading edge or the trailing edge.

According to the present invention, when an image can be formed on the tab, the image formation write timing as the image formation timing is controlled in such a way that an image is formed on both sides of the sheet including the aforementioned tab in the case of the sheet containing a tab based on: the result of detecting the position of the tab in the direction orthogonal to the conveyance direction, the result of detection regarding whether the tab is located at the leading edge or the trailing edge, and the input information on whether the tab is located at the leading edge or the trailing edge.

(17) The image forming apparatus described in any one of the Structures (12) through (16), further comprising information input section where the information on the aforementioned tab of a sheet with a tab is inputted.

According to the present invention, when an image can be formed on the tab, various types of image formation timing are controlled based on: the results of various detections by the tab detecting section, and the information on whether the tab is located at the leading edge or the trailing edge of the sheet.

(18) The image forming apparatus described in any one of the Structures (5) through (11) or the Structure (7), wherein the information on the tab of a sheet with a tab inputted into the information input section includes at least one of the pieces of information on the tab type, tab position, tab width, tab length, number of divided tabs, page to be inserted, necessity of image formation on the tab, and contents of the image to be formed on the tab.

According to the present invention, when an image can be formed on the tab, various types of image formation timing are controlled based on: the results of various detections, by the tab, detecting section, of the information consisting of at least one of the information items on the tab type, tab position, tab width, tab length, number of divided tabs, page to be inserted, necessity of image formation on the tab, and content of the image to be formed on the tab; and the input information on whether the tab is located at the leading edge or the trailing edge of the sheet.

(19) The image forming apparatus described in any one of the Structures (1) through (18), wherein the position of the tab of the sheet fed by the aforementioned feeding section is detected by a plurality of detectors of the tab detecting section before the image is formed.

According to the present invention, the position of the tab of the sheet fed by the aforementioned feeding section is detected by a plurality of detectors of the tab detecting section before the image is formed. This arrangement ensures reliable detection of tab position and provides adequate control.

(20) The image forming apparatus described in any one of the Structures (5) through (11), or the Structure (17) or (18), further comprising an alarm section for sending an error alarm, wherein an alarm is issued by the alarm section if the information on the tab inputted into the aforementioned information input section fails to agree with the result of detection by the tab detecting section.

In the present invention, an alarm section is provided to send an error alarm. When an image is formed on the tab, an alarm is issued from the alarm section to notify the state of error if the inputted information fails to agree with the result of detection.

(21) The image forming apparatus described in any one of the Structures (5) through (11), or the Structures (17) through (19), further comprising an alarm section for sending an error alarm, wherein an alarm is issued by the alarm section if the information on the tab inputted into the aforementioned information input section fails to agree with the result of detection by the tab detecting section; and control is provided to stop image formation operation, if an image cannot be formed on the tab due to the aforementioned disagreement.

In the present invention, an alarm section for sending an error alarm is provided. An alarm is issued by the alarm section if the inputted information fails to agree with the result of detection by the tab detecting section, and control is provided to stop image formation operation, if an image cannot be formed on the tab due to the aforementioned disagreement.

(22) The image forming apparatus described in any one of the Structures (1) through (21), wherein the aforementioned control section calculates the inclination of the sheet fed by the feeding section by referencing the results of detection by a plurality of detectors of the tab detecting section, and corrects the information of an image to be formed by the image forming section in response to the calculated inclination of the sheet.

In the present invention, the inclination of the fed sheet is calculated according to the results of detection by a plurality of detectors of the tab detecting section, and the information on the image to be formed by the image forming section is corrected in response to the calculated inclination of the sheet.

(23) The image forming apparatus described in the Structure (22), wherein correction by the control section is provided in such a way that no inclination occurs to the sheet for the image to be formed thereon.

In the present invention, the inclination of the sheet is calculated according to the results of detection by a plurality of detectors of the tab detecting section, and the information on the image to be formed by the image forming section is corrected in response to the calculated inclination of the sheet. Control is provided in such a way that no inclination occurs to the sheet for the image to be formed thereon.

1. In the Structure (1), the end of the tab of the fed sheet in the feed direction is detected after the sheet has been fed, and the conveyance of the sheet is controlled in such as way as to keep constant the interval between the trailing edge of a sheet in the sheet conveyance direction and the leading edge of the succeeding sheet in the sheet conveyance direction, based on the result of this detection. This arrangement eliminates the need of providing an excess interval and allows an image to be formed with the maximum productivity, even when a sheet with a tab is used.

2. In the Structure (2), the end of the tab of the fed sheet in the feed direction is detected after the sheet has been fed, and detection is made to see whether the tab is located at the leading edge or the trailing edge of the sheet in the sheet conveyance direction. Then the conveyance of the sheet is controlled in such as way as to keep constant the interval between the trailing edge of a sheet in the sheet conveyance direction and the leading edge of the succeeding sheet in the sheet conveyance direction, based on the result of this detection. This arrangement eliminates the need of providing an excess interval and allows an image to be formed with the maximum productivity, even when a sheet with a tab is used.

3. In the Structure (3), the end of the tab of the fed sheet in the feed direction is detected after the sheet has been fed, and the position of the tab in the direction orthogonal to the sheet conveyance direction is detected. Then the conveyance of the sheet is controlled in such as way as to keep constant the interval between the trailing edge of a sheet in the sheet conveyance direction and the leading edge of the succeeding sheet in the sheet conveyance direction, based on the result of this detection. This arrangement eliminates the need of providing an excess interval and allows an image to be formed with the maximum productivity, even when a sheet with a tab is used.

According to the Structure (3), the end of the tab of the fed sheet in the feed direction is detected after the sheet has been fed, and detection is made to see whether the tab is located at the leading edge or the trailing edge of the sheet in the sheet conveyance direction. Then the position of the tab in the direction orthogonal to the sheet conveyance direction is detected, and the conveyance of the sheet is controlled in such as way as to keep constant the interval between the trailing edge of a sheet in the sheet conveyance direction and the leading edge of the succeeding sheet in the sheet conveyance direction, based on these results of this detection. This arrangement eliminates the need of providing an excess interval and allows an image to be formed with the maximum productivity, even when a sheet with a tab is used.

4. In the Structure (4), the end of the tab of the fed sheet in the feed direction is detected after the sheet has been fed, and the conveyance of the sheet is controlled in such as way as to keep constant the interval between the trailing edge of a sheet in the sheet conveyance direction and the leading edge of the succeeding sheet in the sheet conveyance direction, based on the result of this detection. An image is formed on the tab by the image forming section. This arrangement eliminates the need of providing an excess interval and allows an image to be formed with the maximum productivity, even when a sheet with a tab is used.

According to the Structure (4), the end of the tab of the fed sheet in the feed direction is detected after the sheet has been fed, and detection is made to see whether the tab is located at the leading edge or the trailing edge of the sheet in the sheet conveyance direction. The conveyance of the sheet is controlled in such as way as to keep constant the interval between the trailing edge of a sheet in the sheet conveyance direction and the leading edge of the succeeding sheet in the sheet conveyance direction, based on these results of this detection, and the image is formed on the tab by the image forming section. This arrangement eliminates the need of providing an excess interval and allows an image to be formed with the maximum productivity, even when a sheet with a tab is used.

According to the Structure (4), the end of the tab of the fed sheet in the feed direction is detected after the sheet has been fed, and the position of the tab in the direction orthogonal to the sheet conveyance direction is detected. The conveyance of the sheet is controlled in such as way as to keep constant the interval between the trailing edge of a sheet in the sheet conveyance direction and the leading edge of the succeeding sheet in the sheet conveyance direction, based on these results of this detection, and the image is formed on the tab by the image forming section. This arrangement eliminates the need of providing an excess interval and allows an image to be formed with the maximum productivity, even when a sheet with a tab is used.

According to the Structure (4), the end of the tab of the fed sheet in the feed direction is detected after the sheet has been fed, and detection is made to see whether the tab is located at the leading edge or the trailing edge of the sheet in the sheet conveyance direction. The position of the tab in the direction orthogonal to the sheet conveyance direction is detected. The conveyance of the sheet is controlled in such as way as to keep constant the interval between the trailing edge of a sheet in the sheet conveyance direction and the leading edge of the succeeding sheet in the sheet conveyance direction, based on these results of this detection, and the image is formed on the tab by the image forming section. This arrangement eliminates the need of providing an excess interval and allows an image to be formed with the maximum productivity, even when a sheet with a tab is used.

5. In the Structure (5), the end of the tab of the fed sheet in the feed direction is detected after the sheet has been fed, and information on the tab is inputted into the information input section. Then the conveyance of the sheet is controlled in such as way as to keep constant the interval between the trailing edge of a sheet in the sheet conveyance direction and the leading edge of the succeeding sheet in the sheet conveyance direction, based on the result of detection and the input information. This arrangement eliminates the need of providing an excess interval and allows an image to be formed with the maximum productivity, even when a sheet with a tab is used.

According to the Structure (5), the end of the tab of the fed sheet in the feed direction is detected after the sheet has been fed, and detection is made to see whether the tab is located at the leading edge or the trailing edge of the sheet in the sheet conveyance direction. Information on the tab is inputted into the information input section. Then the conveyance of the sheet is controlled in such as way as to keep constant the interval between the trailing edge of a sheet in the sheet conveyance direction and the leading edge of the succeeding sheet in the sheet conveyance direction, based on the result of detection and the input information. This arrangement eliminates the need of providing an excess interval and allows an image to be formed with the maximum productivity, even when a sheet with a tab is used.

According to the Structure (5), the end of the tab of the fed sheet in the feed direction is detected after the sheet has been fed, and the position of the tab in the direction orthogonal to the sheet conveyance direction is detected. Information on the tab is inputted into the information input section. The conveyance of the sheet is controlled in such as way as to keep constant the interval between the trailing edge of a sheet in the sheet conveyance direction and the leading edge of the succeeding sheet in the sheet conveyance direction, based on the result of detection and the input information. This arrangement eliminates the need of providing an excess interval and allows an image to be formed with the maximum productivity, even when a sheet with a tab is used.

According to the Structure (5), the end of the tab of the fed sheet in the feed direction is detected after the sheet has been fed, and detection is made to see whether the tab is located at the leading edge or the trailing edge of the sheet in the sheet conveyance direction. Information on the tab is inputted into the information input section. The conveyance of the sheet is controlled in such as way as to keep constant the interval between the trailing edge of a sheet in the sheet conveyance direction and the leading edge of the succeeding sheet in the sheet conveyance direction, based on the result of detection and the input information. This arrangement eliminates the need of providing an excess interval and allows an image to be formed with the maximum productivity, even when a sheet with a tab is used.

Further, according to the Structure (5), the end of the tab of the fed sheet in the feed direction is detected after the sheet has been fed, and information on the tab is inputted into the information input section. The conveyance of the sheet is controlled in such as way as to keep constant the interval between the trailing edge of a sheet in the sheet conveyance direction and the leading edge of the succeeding sheet in the sheet conveyance direction, based on the result of detection and the input information, and the image is formed on the tab by the image forming section. This arrangement eliminates the need of providing an excess interval and allows an image to be formed with the maximum productivity, even when a sheet with a tab is used.

Further, according to the Structure (5), the end of the tab of the fed sheet in the feed direction is detected after the sheet has been fed, and detection is made to see whether the tab is located at the leading edge or the trailing edge of the sheet in the sheet conveyance direction. Information on the tab is inputted into the information input section. The conveyance of the sheet is controlled in such as way as to keep constant the interval between the trailing edge of a sheet in the sheet conveyance direction and the leading edge of the succeeding sheet in the sheet conveyance direction, based on the result of detection and the input information, and the image is formed on the tab by the image forming section. This arrangement eliminates the need of providing an excess interval and allows an image to be formed with the maximum productivity, even when a sheet with a tab is used.

Further, according to the Structure (5), the end of the tab of the fed sheet in the feed direction is detected after the sheet has been fed, and the position of the tab in the direction orthogonal to the sheet conveyance direction is detected. Information on the tab is inputted into the information input section. Then the conveyance of the sheet is controlled in such as way as to keep constant the interval between the trailing edge of a sheet in the sheet conveyance direction and the leading edge of the succeeding sheet in the sheet conveyance direction, based on the result of detection and the input information, and the image is formed on the tab by the image forming section. This arrangement eliminates the need of providing an excess interval and allows an image to be formed with the maximum productivity, even when a sheet with a tab is used.

Further, according to the Structure (5), the end of the tab of the fed sheet in the feed direction is detected after the sheet has been fed, and detection is made to see whether the tab is located at the leading edge or the trailing edge of the sheet in the sheet conveyance direction. The position of the tab in the direction orthogonal to the sheet conveyance direction is detected, and information on the tab is inputted into the information input section. Then the conveyance of the sheet is controlled in such as way as to keep constant the interval between the trailing edge of a sheet in the sheet conveyance direction and the leading edge of the succeeding sheet in the sheet conveyance direction, based on the result of detection and the input information, and the image is formed on the tab by the image forming section. This arrangement eliminates the need of providing an excess interval and allows an image to be formed with the maximum productivity, even when a sheet with a tab is used.

6. In the Structure (6), the present invention provides control in such a way as to stop the image forming operation, when an image is to be formed on the tab, and the information on the tab inputted into the information input section fails to agree with the position of the tab detected by the tab detecting section. This arrangement ensures reliable image formation when an image is to be formed on a sheet including the tab in the case of a sheet containing a tab, and prevents an unintended image from being formed or an image from being formed out of the sheet.

7. In the Structure (7), the present invention provides control in such a way as to stop the image forming operation, when an image is to be formed on the tab, and the information on the tab inputted into the information input section fails to agree with the position of the tab, detected by the tab detecting section, of the sheet fed by the feeding section. This arrangement ensures reliable image formation when an image is to be formed on a sheet including the tab in the case of a sheet containing a tab, and prevents an unintended image from being formed or an image from being formed out of the sheet.

8. In the Structure (8), the present invention provides control in such a way as to stop the image forming operation, when an image is to be formed on the tab, and the information on the tab inputted into the information input section fails to agree with the position of the tab, detected by the tab detecting section, of the sheet fed by the feeding section before formation of the image. This arrangement ensures reliable image formation when an image is to be formed on a sheet including the tab in the case of a sheet containing a tab, and prevents an unintended image from being formed or an image from being formed out of the sheet.

9. In the Structure (9), the present invention provides control in such a way as to stop the image forming operation, when an image is to be formed on the tab, and the information on the tab inputted into the information input section fails to agree with the position of the tab, detected by the tab detecting section, of the sheet fed by the feeding section before formation of the image on each side in the step of both-side image formation. This arrangement ensures reliable image formation when a both-side image is to be formed on a sheet including the tab in the case of a sheet containing a tab, and prevents an unintended image from being formed or an image from being formed out of the sheet.

10. In the Structure (10), the present invention provides control in such a way as to stop the image forming operation, when an image is to be formed on the tab, and the information on the tab inputted into the information input section fails to agree with the position of the tab, in the direction orthogonal to the sheet conveyance direction, detected by the tab detecting section. This arrangement ensures reliable image formation when an image is to be formed on a sheet including the tab in the case of a sheet containing a tab, and prevents an unintended image from being formed or an image from being formed out of the sheet.

According to the Structure (10), the present invention provides control in such a way as to stop the image forming operation, when an image is to be formed on the tab, and the information on the tab inputted into the information input section fails to agree with the position of the tab, in the direction orthogonal to the sheet conveyance direction, detected by the tab detecting section, of the sheet fed by the feeding section. This arrangement ensures reliable image formation when an image is to be formed on a sheet including the tab in the case of a sheet containing a tab, and prevents an unintended image from being formed or an image from being formed out of the sheet.

According to the Structure (10), the present invention provides control in such a way as to stop the image forming operation, when an image is to be formed on the tab, and the information on the tab inputted into the information input section fails to agree with the position of the tab, in the direction orthogonal to the sheet conveyance direction, detected by the tab detecting section, of the sheet fed by the feeding section prior to image formation. This arrangement ensures reliable image formation when an image is to be formed on a sheet including the tab in the case of a sheet containing a tab, and prevents an unintended image from being formed or an image from being formed out of the sheet.

According to the Structure (10), the present invention provides control in such a way as to stop the image forming operation, when an image is to be formed on the tab, and the information on the tab inputted into the information input section fails to agree with the position of the tab, in the direction orthogonal to the sheet conveyance direction, detected by the tab detecting section, of the sheet fed by the feeding section prior to image formation before formation of the image on each side in the step of both-side image formation. This arrangement ensures reliable image formation when an image is to be formed on a sheet including the tab in the case of a sheet containing a tab, and prevents an unintended image from being formed or an image from being formed out of the sheet.

11. In the Structure (11), the present invention provides control in such a way as to stop the image forming operation, when an image is to be formed on the tab, and the information on the tab inputted into the information input section fails to agree with the position of the tab, in the sheet conveyance direction, detected by the tab detecting section. This arrangement ensures reliable image formation when an image is to be formed on a sheet including the tab in the case of a sheet containing a tab, and prevents an unintended image from being formed or an image from being formed out of the sheet.

According to the Structure (11), the present invention provides control in such a way as to stop the image forming operation, when an image is to be formed on the tab, and the information on the tab inputted into the information input section fails to agree with the position of the tab, in the sheet conveyance direction, detected by the tab detecting section, of the sheet fed by the feeding section. This arrangement ensures reliable image formation when an image is to be formed on a sheet including the tab in the case of a sheet containing a tab, and prevents an unintended image from being formed or an image from being formed out of the sheet.

According to the Structure (11), the present invention provides control in such a way as to stop the image forming operation, when an image is to be formed on the tab, and the information on the tab inputted into the information input section fails to agree with the position of the tab, in the sheet conveyance direction, detected by the tab detecting section, of the sheet fed by the feeding section before formation of the image. This arrangement ensures reliable image formation when an image is to be formed on a sheet including the tab in the case of a sheet containing a tab, and prevents an unintended image from being formed or an image from being formed out of the sheet.

According to the Structure (11), the present invention provides control in such a way as to stop the image forming operation, when an image is to be formed on the tab, and the information on the tab inputted into the information input section fails to agree with the position of the tab, detected by the tab detecting section, of the sheet fed by the feeding section before formation of the image on each side in the step of both-side image formation. This arrangement ensures reliable image formation when an image is to be formed on both sides of the sheet including the aforementioned tab in the case of the sheet containing a tab, and prevents an unintended image from being formed or an image from being formed out of the sheet.

12. In the Structure (12), when an image can be formed on the tab, image formation timing is controlled, based on the result of detection made by the tab detecting section and the input information on whether the tab is located at the leading edge or the trailing edge of the sheet. This arrangement ensures an intended image to be formed when a tab-containing sheet is used.

13. In the Structure (13), when an image can be formed on the tab, image formation timing is controlled, based on the position of the tab in the direction orthogonal to the sheet conveyance direction, detected by the tab detecting section, and the input information on whether the tab is located at the leading edge or the trailing edge of the sheet. This arrangement ensures an intended image to be formed when a tab-containing sheet is used.

14. In the Structure (14), when an image can be formed on the tab, image formation timing is controlled, based on the result of detection on whether the tab is located at the leading edge or the trailing edge of the sheet, and the input information on whether the tab is located at the leading edge or the trailing edge of the sheet. This arrangement ensures an intended image to be formed when a tab-containing sheet is used.

According to the Structure (14), when an image can be formed on the tab, image formation timing is controlled, based on the result of detection on the position of the tab in the direction orthogonal to the sheet conveyance direction; the result of detection on whether the tab is located at the leading edge or the trailing edge of the sheet; and the input information on whether the tab is located at the leading edge or the trailing edge of the sheet.

15. In the Structure (15), when an image can be formed on the tab, image formation timing is controlled, based on the result of detection by the tab detecting section, and the input information on whether the tab is located at the leading edge or the trailing edge of the sheet, in such a way as to form an image on both sides of the sheet including the tab in the case of the sheet containing a tab. This arrangement ensures an intended image to be formed when a tab-containing sheet is used.

According to the Structure (15), when an image can be formed on the tab, image formation timing is controlled, based on the position of the tab in the direction orthogonal to the sheet conveyance direction, detected by the tab detecting section, and the input information on whether the tab is located at the leading edge or the trailing edge of the sheet, in such a way as to form an image on both sides of the sheet including the tab in the case of the sheet containing a tab. This arrangement ensures an intended image to be formed when a tab-containing sheet is used.

According to the Structure (15), when an image can be formed on the tab, image formation timing is controlled, based on the result of detection on whether the tab is located at the leading edge or the trailing edge of the sheet, and the input information on whether the tab is located at the leading edge or the trailing edge of the sheet, in such a way as to form an image on both sides of the sheet including the tab in the case of the sheet containing a tab. This arrangement ensures an intended image to be formed when a tab-containing sheet is used.

According to the Structure (15), when an image can be formed on the tab, image formation timing is controlled, based on the result of detection on the position of the tab in the direction orthogonal to the sheet conveyance direction; the result of detection on whether the tab is located at the leading edge or the trailing edge of the sheet; and the input information on whether the tab is located at the leading edge or the trailing edge of the sheet, in such a way as to form an image on both sides of the sheet including the tab in the case of the sheet containing a tab. This arrangement ensures an intended image to be formed when a tab-containing sheet is used.

16. In the Structure (16), when an image can be formed on the tab, image formation write timing as image formation timing is controlled, based on the result of detection by the tab detecting section, and the input information on whether the tab is located at the leading edge or the trailing edge of the sheet. This arrangement ensures an intended image to be formed when a tab-containing sheet is used.

According to the structure (16), when an image can be formed on the tab, image formation write timing as image formation timing is controlled, based on the position of the tab in the direction orthogonal to the sheet conveyance direction, detected by the tab detecting section, and the input information on whether the tab is located at the leading edge or the trailing edge of the sheet. This arrangement ensures an intended image to be formed when a tab-containing sheet is used.

According to the structure (16), when an image can be formed on the tab, image formation write timing as image formation timing is controlled, based on: the result of detection on whether the tab is located at the leading edge or the trailing edge of the sheet, and the input information on whether the tab is located at the leading edge or the trailing edge of the sheet. This arrangement ensures an intended image to be formed when a tab-containing sheet is used.

According to the structure (16), when an image can be formed on the tab, image formation write timing as image formation timing is controlled, based on; the result of detection on the position of the tab in the direction orthogonal to the sheet conveyance direction; the result of detection on whether the tab is located at the leading edge or the trailing edge of the sheet; and the input information on whether the tab is located at the leading edge or the trailing edge of the sheet.

According to the structure (16), when an image can be formed on the tab, image formation write timing as image formation timing is controlled, based on: the result of detection by the tab detecting section and the input information on whether the tab is located at the leading edge or the trailing edge of the sheet; in such a way as to form an image on both sides of the sheet including the tab in the case of the sheet containing a tab. This arrangement ensures an intended image to be formed when a tab-containing sheet is used.

According to the structure (16), when an image can be formed on the tab, image formation write timing as image formation timing is controlled, based on: the position of the tab in the direction orthogonal to the sheet conveyance direction, detected by the tab detecting section, and the input information on whether the tab is located at the leading edge or the trailing edge of the sheet; in such a way as to form an image on both sides of the sheet including the tab in the case of the sheet containing a tab. This arrangement ensures an intended image to be formed when a tab-containing sheet is used.

According to the structure (16), when an image can be formed on the tab, image formation write timing as image formation timing is controlled, based on: the result of detection on the position of the tab in the direction orthogonal to the sheet conveyance direction, and the input information on whether the tab is located at the leading edge or the trailing edge of the sheet; in such a way as to form an image on both sides of the sheet including the tab in the case of the sheet containing a tab. This arrangement ensures an intended image to be formed when a tab-containing sheet is used.

According to the structure (16), when an image can be formed on the tab, image formation write timing as image formation timing is controlled, based on the result of detection on the position of the tab in the direction orthogonal to the sheet conveyance direction; the result of detection on whether the tab is located at the leading edge or the trailing edge of the sheet; and the input information on whether the tab is located at the leading edge or the trailing edge of the sheet, in such a way as to form an image on both sides of the sheet including the tab in the case of the sheet containing a tab. This arrangement ensures an intended image to be formed when a tab-containing sheet is used.

17. In the Structure (17), when an image can be formed on the tab, various types of image formation timing are controlled, based not only on the results of various detections by the tab detecting section, but also on the input information from the information input section on whether the tab is located at the leading edge or the trailing edge of the sheet. This arrangement ensures an intended image to be formed when a tab-containing sheet is used.

18. In the Structure (18), when an image can be formed on the tab, various types of image formation timing are controlled, based on: the results of various detections, by the tab detecting section, of the information consisting of at least one of the information items on the tab type, tab position, tab width, tab length, number of divided tabs, page to be inserted, necessity of image formation on the tab, and content of the image to be formed on the tab; and the input information on whether the tab is located at the leading edge or the trailing edge of the sheet. This arrangement ensures an intended image to be formed when an image is to be formed on one side or both sides of the sheet including the tab in the case of the sheet containing a tab, wherein various types of tab-containing sheets are used.

19. In the Structure (19), the position of the tab of the sheet fed by the feeding section is detected by the tab detecting section containing a plurality of detectors. This arrangement ensures reliable position detection and adequate control.

20. In the Structure (20), an alarm section is provided to send an error alarm. When an image is formed on the tab, an alarm is issued from the alarm section to notify the state of error if the inputted information fails to agree with the result of detection. This arrangement improves the usability for a user.

21. In the Structure (21), an alarm section is provided to send an error alarm. When an image is formed on the tab, an alarm is issued from the alarm section to notify the state of error if the inputted information fails to agree with the result of detection. Further, control is provided to stop image formation operation, if an image cannot be formed on the tab due to the aforementioned disagreement. This arrangement improves the usability for a user, and avoids formation of an image that is not intended by the user.

22. In the Structure (22), the inclination of the sheet fed by the feeding section is calculated based on the results of detection by a plurality of detectors of the tab detecting section, and the information on the inclination of an image to be formed by the image forming section is corrected in response to the calculated inclination of the sheet. Accurate image formation on the tab of a tab-containing sheet is ensured by the correction of image information. Moreover, accurate image formation is also provided on other portions than the tab.

23. In the Structure (23), the inclination of the fed sheet is calculated according to the results of detection by a plurality of detectors of the tab detecting section, and the information on the image to be formed by the image forming section is corrected in response to the calculated inclination of the sheet. Control is provided in such a way that no inclination occurs to the sheet for the image to be formed thereon. Accurate image formation on the tab of a tab-containing sheet is ensured by the correction of image information. Moreover, accurate image formation is also provided on other portions than the tab.

### BRIEF DESCRIPTION OF THE DRAWINGS

FIG. 1 is a functional block diagram showing an electronic configuration in an image forming apparatus as an embodiment of the present invention;

FIG. 2 is configuration block diagram showing a mechanical configuration in an image forming apparatus as an embodiment of the present invention;

FIG. 3 is a flowchart showing operational procedures in an image forming apparatus as an embodiment of the present invention;

FIGS. 4(a) and 4(b) are explanatory diagrams showing the processing executed in the embodiment of the present invention;

FIGS. 5(a) through 5(d) are explanatory diagrams showing the processing executed in the embodiment of the present invention;

FIGS. 6(a) and 6(b) are explanatory diagrams showing the processing executed in the embodiment of the present invention;

FIGS. 7(a) through 7(c) are explanatory diagrams showing the processing executed in the embodiment of the present invention;

FIGS. 8(a) through 8(d) are explanatory diagrams showing the processing executed in the embodiment of the present invention;

FIG. 9 is a flowchart showing the processing executed in the embodiment of the present invention;

FIG. 10 is a flowchart showing the processing executed in the embodiment of the present invention;

FIG. 11 is an explanatory diagram showing the processing executed in the embodiment of the present invention;

FIGS. 12(a) through 12(h) are explanatory diagrams showing the position of the tabs of two sheets fed in the sheet conveyance direction in the embodiment of the present invention, and the concept of control of intervals between sheets;

FIG. 13 is a flowchart showing the details of the calculation of sheet interval data in the conveyance control carried out in the embodiment of the present invention;

FIGS. 14(a) through 14(e) are explanatory diagrams showing the correction of timing in the embodiment of the present invention;

FIG. 15 is an explanatory diagram showing a tab-containing sheet used in the image forming apparatus;

FIG. 16 is an explanatory diagram showing a tab-containing sheet used in the image forming apparatus; and

FIGS. 17(a) through 17(d) are explanatory diagrams showing a tab-containing sheet used in the image forming apparatus.

### DETAILED DESCRIPTION OF THE PREFERRED EMBODIMENT

Hereinafter, a detailed description is given of preferred embodiments of the invention (simply the embodiments, hereinafter) with reference to the accompanying drawings. Note that this invention is applicable to both an information forming apparatus (copying apparatus) equipped with the function to scan contents of an object to be copied as image information by using a document reading means (scanner) and an information forming apparatus without a document reading means (scanner). Further, the present invention can be applied to even an image forming apparatus such as a multi-functional machine equipped with a facsimile function.

### First Embodiment

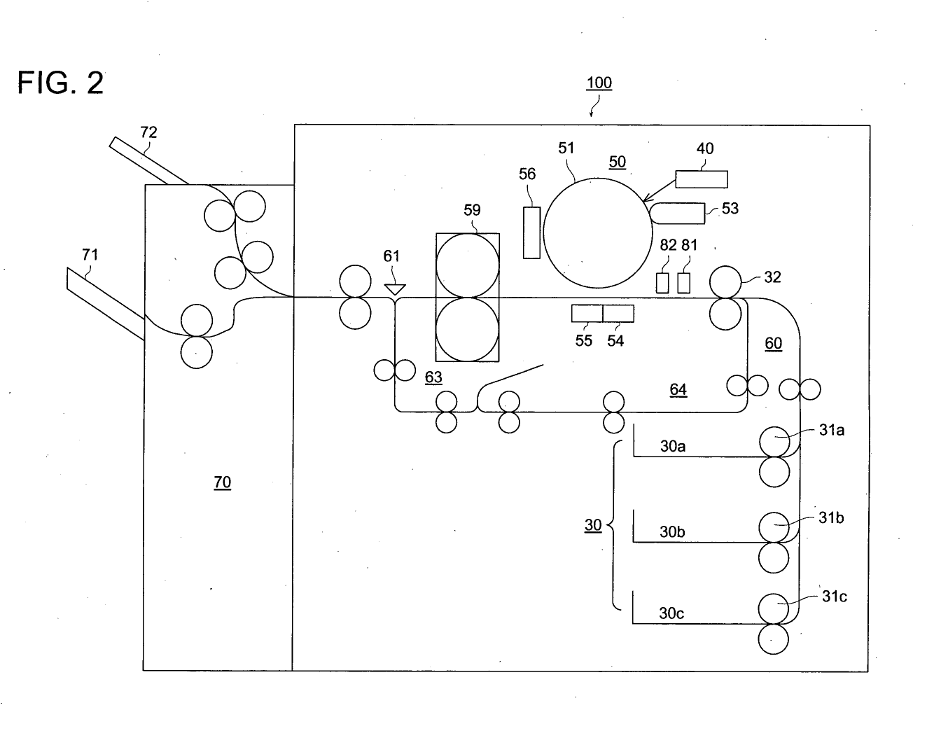

Referring to FIG. 2, a mechanical configuration within the overall configuration of an apparatus, to which an image forming device of the embodiment is applied, is described.

Mechanical Configuration and Overall Operation of the Image Forming Apparatus

First, a mechanical configuration of the image forming apparatus is described with reference to FIG. 2. Note that a copying machine that scans images from hard copies and conducts image formation is used as a specific example of the present embodiment. Further, here, an image forming apparatus is used for the specific example as a copying machine employing an electrophotographic method.

In FIG. 2, numeral 30 denotes a feeding section that feeds stacked sheets of paper, numeral 40 denotes a writing section that generates light beams for exposure in accordance with image data, numeral 50 denotes an image forming section that uses the electrostatic printing method to record image data onto recording medium p (generally referred to as recording paper or transfer paper, but referred to as a sheet in this document), numeral 60 denotes a conveying and driving means for conveying sheets, and numeral 70 denotes a finisher section that conducts post-processing such as sorting.

Also, numeral 81 denotes a tab detection sensor composed of a plurality of light receiving elements and light emitting elements arranged in the main scanning direction (direction perpendicular to FIG. 2, and perpendicular to conveyance direction) that detects tab positions, tab widths, tab types, and tab lengths.

Here, following an image formation command, the sheet p is sent out from one of paper feed trays 30a to 30c, in which the sheet p is loaded, by one of the first paper feed rollers 31a to 31c, and is fed to the image forming section 50.

Note that, in the present embodiment, a plurality of paper feed trays are installed so that the sheet insertion, or inter-sheet function can feed sheets from different trays. Here, paper feed trays 30a to 30c and the first paper feed rollers 31a to 31c constitute a paper feed means to feed the sheet p. Incidentally, here, three stories of sheet feed trays as plural sheet feed trays are provided as an example. However, the invention is not limited to the example.

The sheet p to be fed to the image forming section 50 becomes synchronized with formation of a toner image on the photoreceptor drum 51 by a second paper feed roller (registration roller) 32 near the inlet of the section so that a distance between adjoining sheets is constant (Ti), and then comes close to a photoreceptor drum 51 as an image bearing body.

After that, the leading edge of the sheet P is detected by the leading edge detection sensor 82, and the irradiation timing of the laser beam, which will be described later, in the photoreceptor drum 51 is determined in response to the result of this detection.

Image data is inputted to the writing section 40 by the recorded image processor, and a laser diode within the writing section 40 applies a laser beam to the photoreceptor drum 51 in accordance with the result of detection of the sheet P by the leading edge detection sensor 82 to form an electrostatic latent image. An image developing section 53 develops the electrostatic latent image, and a toner image is formed on the photoreceptor drum 51.

The toner image is then transferred onto the sheet p by a transfer section 54 underneath the photoreceptor drum 51. The sheet p, pressed to the photoreceptor drum 51 by pressure, is then separated from the drum by a separation section 55. The sheet p separated from the photoreceptor drum 51 enters a fuser 59 via a conveyance mechanism, and then the toner image becomes fixed by heat and pressure. An image thus becomes formed onto the sheet p.

Note that, at need, the sheet p with fused toner image is conveyed into the lower part via a guide 61 and then enters a reverse conveyer section 63. The sheet p in the reverse conveyer section 63 is again conveyed by reverse rollers and enters again the image forming section 50 via a reverse conveyance route 64. In the image forming section 50 where image forming is completed for one side of the aforementioned document d, the toner on the photoreceptor drum 51 is removed by a cleaner 56 and then the drum is electrically charged by a charger 52 to prepare for the next image forming session.

In this state, the other side of the sheet p (the side with no image formed yet) becomes loaded into the image forming section 50, and an image is formed. The sheet p separated from the photoreceptor drum 51 by the separation section 55, again enters the fuser 59, via the conveyance mechanism 58, to be fixed with the image.

The sheet p with images formed on both sides or the sheet p with images formed on one side then is sent to a finisher section 70. In the finisher section 70, there are a designated tray 71 and an undesignated tray 72. The sheet is ejected to one of the trays depending on the result of detection by the tab detection sensor.

Hence, the second rollers 32 and sections that convey the sheet after it is through the roller, such as various conveyance rollers and conveyance belts, constitute a conveying and driving means 60, and in the present embodiment, specified control is executed to conveying operations by the conveying and driving means 60.

Note that, in the present embodiment, both sheets without tabs and with tabs are fed by the feeding section 30, and before transferring, the tab detection sensor 81 determines whether the sheets have tabs or not, and also detects tab positions and tab directions for the fed sheets (without tabs or with tabs). Then images are formed by the image forming section 50 onto the sheets with tabs, including the tab as a target area for image formation.

It is preferred that the tab detection sensor 81 be capable of detection prior to image formation, and is further preferred that the tab detection sensor 81 be capable of detection on each surface at the time of both-side image formation. Thus, as shown in FIG. 2, a tab detection sensor 81 is arranged along the path to be followed in the case of reverse-side image formation.

It is sufficient only if detection can be made before image formation. Thus, it is also possible to arrange such a configuration that information on the tab can be obtained when the sheet is located on a tray, moving on the tray, or positioned immediately after having been fed from the tray.

Further, when there is a disagreement between the inputted information on the tab of a tab-containing sheet and the result of detection by the tab detection sensor 81, as a result of the sheet having been sorted and ejected onto any one of the trays in response to the result of detection by the tab detection sensor 81, the finisher section 70 allows the sheet to be ejected into a tray other than the specified tray for normal use. This minimizes the confusion on the part of the user.

Electronic Configuration of the Image Forming Apparatus

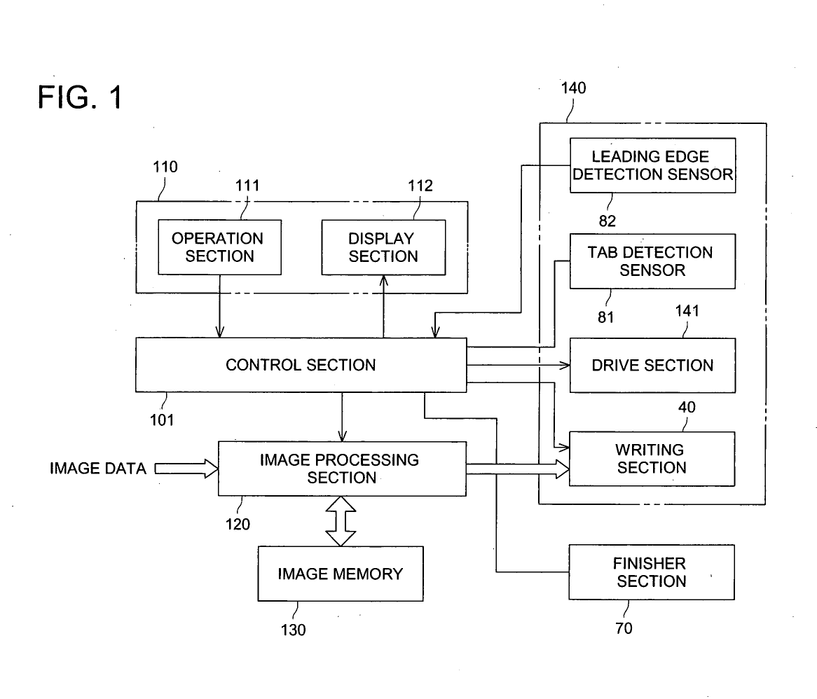

FIG. 1 is a block drawing showing a detailed electric configuration within the image forming apparatus of the first embodiment.

Numeral 100 denotes a type of an image forming apparatus that forms and outputs images onto sheets of paper including sheets with tabs.

This image forming apparatus 100 is provided with: an overall control section 101 that executes controls that are related to sheets with tabs, in addition to controls for the overall apparatus; an operation and display section 110 that is used for making various operational inputs and for displaying apparatus status; an image processing section 120 that executes image processing for sheets with tabs, in addition to regular image processing; an image memory 130 that expands or holds image data to be processed by the image processing section 120 or other various types of data; and a print engine 140 that forms image data onto sheets.

Also, as necessary, the apparatus can be equipped with the finisher section 70 that sorts sheets with formed images. Note that the overall control section 101 constitutes a control means for controlling image formation in the present embodiment.

The operation and display section 110 is provided with: an operation section 111 as an information input section for receiving inputs of information on the tab of the tab-containing sheet (including the tab type, tab position (tab position in the sheet conveyance direction, tab position in the direction orthogonal to sheet conveyance direction)), tab width, tab length, number of divided tabs, tab direction (tab located at the leading edge or trailing edge in the sheet conveyance direction, or on the side orthogonal to the sheet conveyance direction), the leading edge of the sheet in the sheet conveyance direction when the tab is located at the leading edge (front end of the sheet) in the sheet conveyance direction, the trailing edge of the sheet in the sheet conveyance direction when the tab is located at the leading edge (rear end of the sheet) in the sheet conveyance direction, page to be inserted, presence or absence of tab image formation (image formed side), and contents of images to be formed on tab); and a display section 112 for displaying various types of information and statuses.

Furthermore, the display section 112 and a buzzer and a warning lamp, which are not shown in the drawing, constitute a notification means for making notifications by outputting alarm displays, alarm sounds, alarm voice messages, or simultaneous output of any combinations of the above.

The print engine 140 contains: a writing section 40 (FIG. 2) for writing in response to the image data processed by the image processing section 120; a tab detection sensor 81 as a tab detector; a leading edge detection sensor 82 (FIG. 2) for detecting the leading edge of the sheet during conveyance, for synchronizing the sheet conveyance timing with the image formation timing; and a drive section 141 for feeding and conveying various types of sheets.

Before an image is formed on the fed sheet, the tab detection sensor 81 checks whether the sheet has a tab or not. If it is a tab-containing sheet, the tab detection sensor 81 checks the tab type, tab position (tab position in the sheet conveyance direction, tab position in the direction orthogonal to the sheet conveyance direction), tab width, tab length, the number of divided tabs, tab direction (tab located at the leading edge or trailing edge in the sheet conveyance direction, or on the side orthogonal to the sheet conveyance direction), the leading edge of the sheet in the sheet conveyance direction when the tab is located at the leading edge (front end of the sheet) in the sheet conveyance direction, the trailing edge of the sheet in the sheet conveyance direction when the tab is located at the leading edge (rear end of the sheet) in the sheet conveyance direction, page to be inserted, presence or absence of tab image formation (image formed side), and contents of images to be formed on tab).

This image forming apparatus 100 can be applied to various types of apparatus such as copying machines, facsimiles, and printers. Also, the print engine 140 can be of an electrophotographic type that uses laser beams, an LED print head type, an ink jet type, a thermal type, or a die sublimation type.

Operational Description of the Embodiment

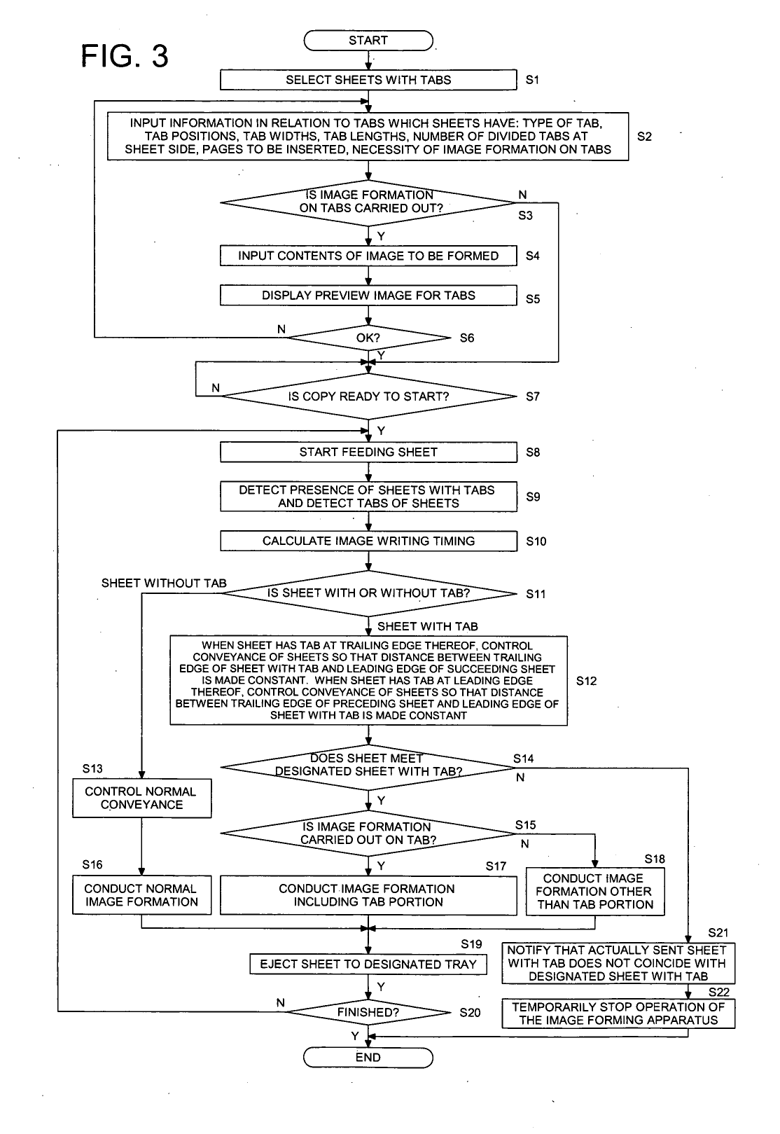

Operations of an image forming apparatus as described above are described with reference to FIG. 3. Note that the flowchart shown in FIG. 3 is the one that is called within the image formation control program operating in the overall control section 101.

Note that in the following operation description of the embodiment, the overall control section 101, and controls or operations by sub-routines of the image formation control programs (computer program) will be simply referred to as control of the overall control section 101.

First, assume that a user selects through the control section 111 to use sheets with tabs (S1). Generally, sheets with tabs are used as intersheets. In other words, assume that “Advanced Function” is selected by way of the control section 111, “intersheet” is then selected, and finally “sheet with tab” is selected as intersheet.

Here, the control section 101 displays a screen on the display section 112 to accept inputs of various types of information regarding the sheets with tabs, and receives various types of tab information as “Information on Tabs on Sheets with Tabs” from the user (S2), wherein this information includes the tab type, tab position (tab position in the sheet conveyance direction, tab position in the direction orthogonal to the sheet conveyance direction), tab width, tab length, the number of divided tabs, tab direction (tab located at the leading edge or trailing edge in the sheet conveyance direction, or on the side orthogonal to the sheet conveyance direction), the leading edge of the sheet in the sheet conveyance direction when the tab is located at the leading edge (front end of the sheet) in the sheet conveyance direction, the trailing edge of the sheet in the sheet conveyance direction when the tab is located at the leading edge (rear end of the sheet) in the sheet conveyance direction, page to be inserted, presence or absence of tab image formation (image formed side (single side-front side, single side-back side or both sides)).

The control section 101 can be arranged in such a configuration that a communication means such as a network (not illustrated), a linkage means or a memory card is used to get various types of information on the tab-containing sheet, including the tab type, tab position (tab position in the sheet conveyance direction, tab position in the direction orthogonal to the sheet conveyance direction), tab width, tab length, the number of divided tabs, tab direction (tab located at the leading edge or trailing edge in the sheet conveyance direction, or on the side orthogonal to the sheet conveyance direction), the leading edge of the sheet in the sheet conveyance direction when the tab is located at the leading edge (front end of the sheet) in the sheet conveyance direction, the trailing edge of the sheet in the sheet conveyance direction when the tab is located at the leading edge (rear end of the sheet) in the sheet conveyance direction, page to be inserted, presence or absence of tab image formation (image formed side (single side-front side, single side-back side, or both sides)).

When the user inputs an instruction to form images onto the tabs in the operation section 111 (Y in S3 of FIG. 3), the control section 101 receives via the operation section 111 inputs of letters and characters or symbols to be formed onto the tabs (S4).

It is also possible to make such arrangements that the letters and characters or symbols to be formed onto the tabs, together with image data or separately therefrom, is received in the form of electronic data from an external device.

If image formation onto the tabs is specified for only one side of sheets, then inputs of letters and characters or symbols for one side of the tabs are accepted, and if image formation onto the tabs is specified for both sides of sheets, then inputs of letters and characters or symbols for each side of the tabs are accepted.

When letters and characters or symbols to be formed onto the aforementioned tabs are accepted, the control section 101 creates a preview of how images will be formed onto the tabs and then displays it in the display section 112 (S5).

In this way, without making complicated settings for various types of sheets with tabs, it is possible to see beforehand how images are formed on one or both sides of sheets with tabs with the tab included as a target area for image formation so that image formation can be conducted with no mistakes. Also, in this way, not only letters and characters or symbols scanned by a scanner but also those inputted via the control section can be formed onto the tabs with no mistakes.

If the user for some reason wishes to redo the settings after checking the preview screen (N in S6), the control section 101 returns to the tab information input step (S2) so that various settings of the sheets with the tabs and also inputs of letters and characters and symbols to be formed onto the tabs will be made again.

If the user checks and approves the preview screen (Y in S6), the control section 101 enters copy start standby mode (S7). If the copy start key on the operation section 111 is pressed in this state, the control section 101 starts the image formation process based on the conditions set for the supplied image data (Y in S7).

Here, the control section 101 feeds the sheets from the paper feed trays 30a to 30c (S8). Note that when images must be formed onto sheets without tabs for particular pages, sheets are fed from the feeding section in which sheets without tabs are stacked, and when images must be formed onto sheets with tabs for particular pages, sheets are fed from the feeding section in which sheets with tabs are stacked.

In the description of the present embodiment, normal operations in which sheets with no tabs are fed will be omitted since they are already well known, and operations when sheets with tabs are fed will be described in detail.

Regarding the sheets fed by the feeding section 30, the tab detection sensor 81 located at the position before image formation determines whether or not the fed sheets of paper have a tab or not and also detects position and direction of tabs on fed sheets with tabs (S9). Incidentally, specific example regarding tab detection will be explained later.

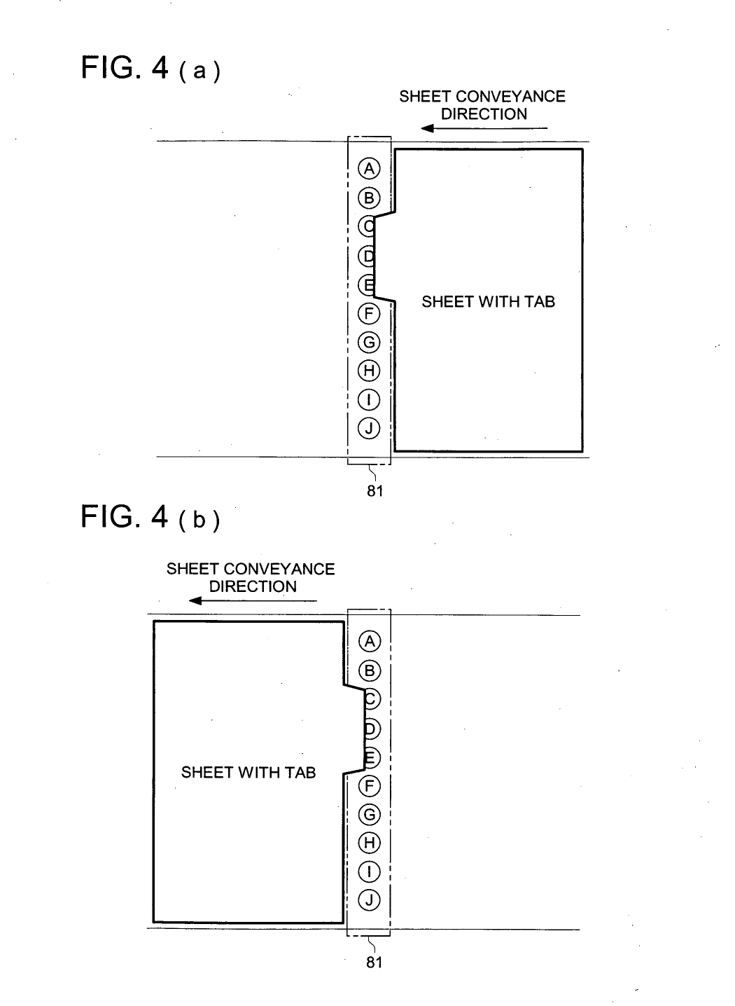

FIGS. 4(a) and 4(b) are explanatory drawings showing operation patterns of the tab detection sensor 81. Here, the tab detection sensor 81 composed of a plurality of sensors A to J. It may is composed of a larger number of sensors in actual practice. Here, drawings show examples of two cases: the case in which the tab on a sheet with a tab is located at the leading edge of the sheet (upstream) (FIG. 4(a)), and the case in which the tab on a sheet with a tab is located at the trailing edge of the sheet (downstream) (FIG. 4(b)).

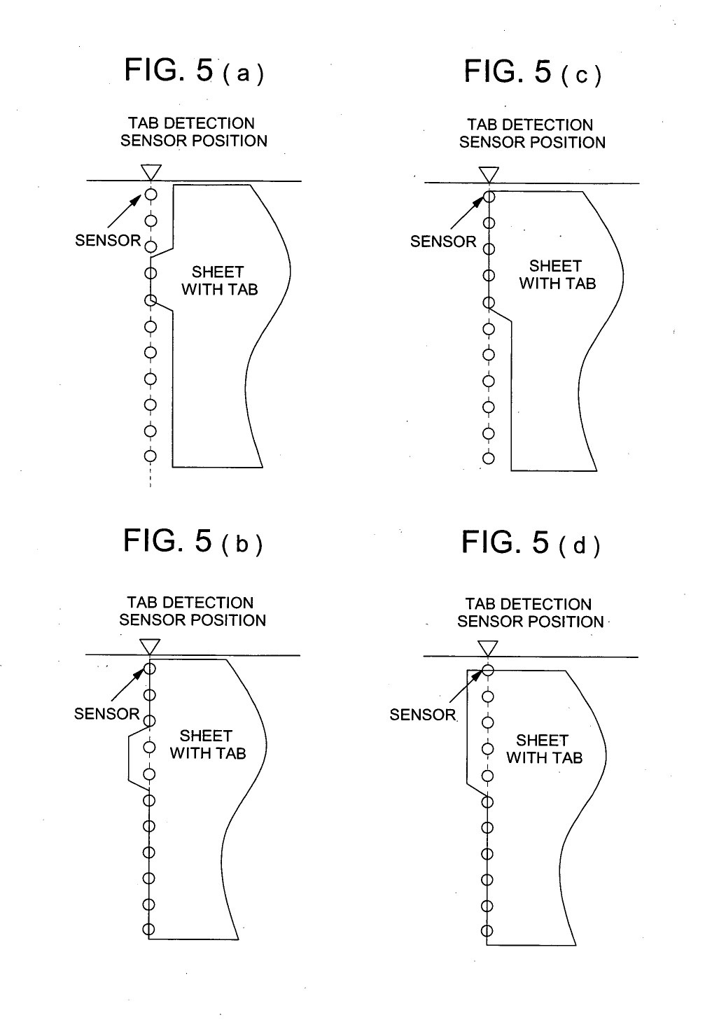

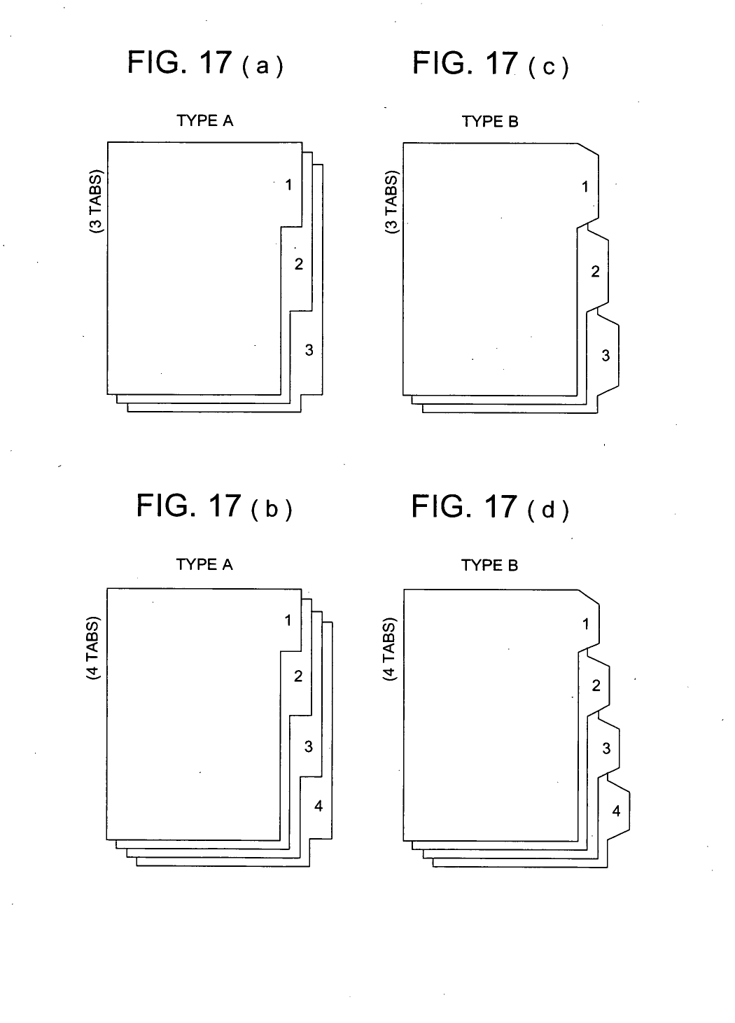

As seen in FIGS. 5(a) and 5(b) as well as FIGS. 5(c) and 5(d), the sensor detects tab lengths, tab widths, tab positions (see FIGS. 16 and 17), and tab directions (whether the tab is located upstream or downstream) based on timing differentials between the tab and the other part (non-tab portion) for passing the plurality of sensors. In FIGS. 5(a) to 5(d), if the sheet is conveyed from left to right, it means that the tab is located at the trailing edge of the sheet, and if the sheet is conveyed from right to left, it means that the tab is located at the leading edge of the sheet.

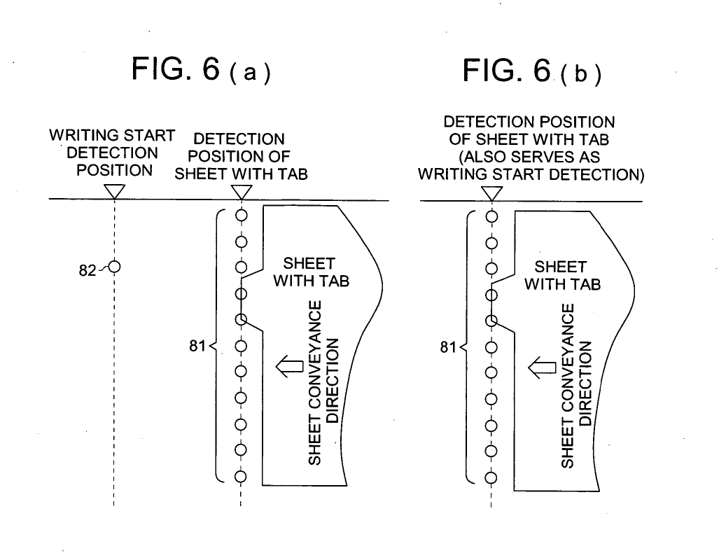

Note that, when starting the exposure process to the image bearing body after detecting the leading edge of the sheet in the sheet conveyance direction at the time of paper feed, it is possible to use the result of detection provided by the tab detection sensor 81 to control starting of the exposure process (FIG. 6(b)) instead of using a leading edge detection sensor 82 dedicated to detect the leading edge of a sheet in the sheet conveyance direction (FIG. 6(a)). By using this configuration, the use of the dedicated leading edge detection sensor 82 becomes unnecessary, and it becomes thus possible to save ports on a microcomputer.

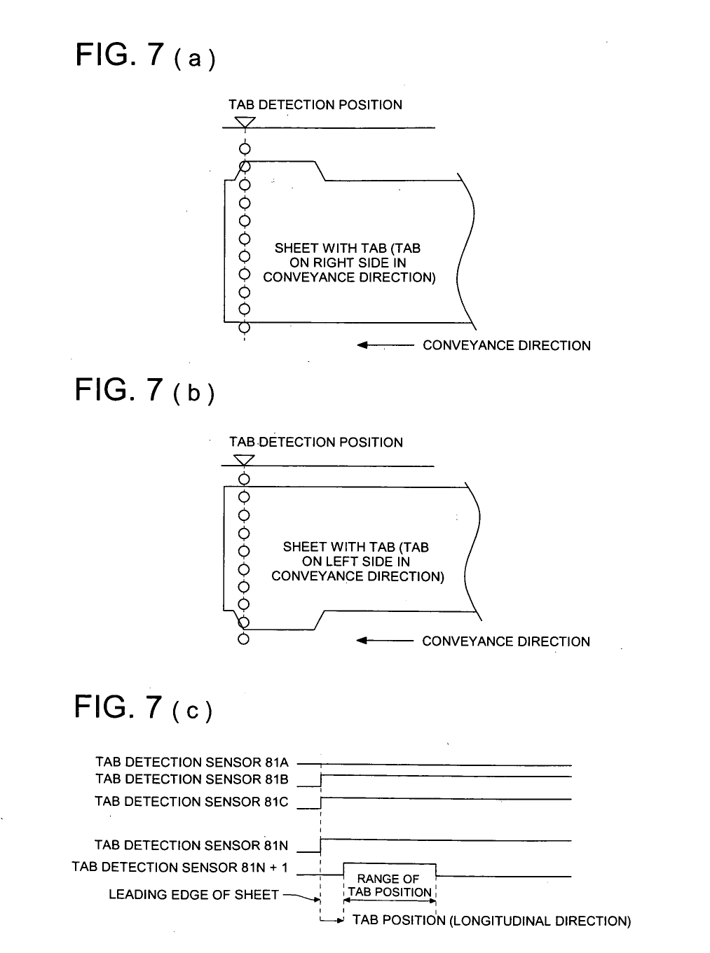

FIGS. 4(a) and 4(b), FIGS. 5(a) through 5(d), and FIGS. 6(a) and 6(b) show specific examples when a tab is present in the direction orthogonal to the sheet conveyance direction. As shown in FIGS. 7(a) through 7(c), the present embodiment is also applicable to the case where a tab is present in the direction parallel to the sheet conveyance direction, i.e. where the sheet is fed in the longitudinal direction.

For example, a tab may be present on the right in the sheet conveyance direction, as shown in FIG. 7(a), or on the left, as shown in FIG. 7(b). In such a case, the right or left position is determined, depending on whether the portion corresponding to the tab position range occurs on the right of the sheet or on the left, according to the results of detection by the tab detection sensors 81 (tab detection sensors 81A through 81N+1) in the state shown in FIG. 7(b). Further, the tab position and tab length (tab position range) are calculated by measuring the signal range by a timer.

Now, return to the flowchart of FIG. 3 to continue the operational description: If a fed sheet is judged as being a sheet without a tab (“sheet without tab” in S11) as a result of detection of tab position and direction for a sheet with a tab (S9), then normal conveyance control is executed (S13). Here, the normal conveyance control refers to conveyance control in which the distance between the position of the upstream leading edge in the sheet conveyance direction of a preceding sheet and the position of the upstream leading edge in the sheet conveyance direction f a succeeding sheet is kept constant.

After sheet-with-tab and tab detection (S9), image write timing is calculated (S10). When the result of sheet-with-tab and tab detection (S9) has indicated that the sheet has a tab (“sheet with tab” in S11), conveyance control specific to the present embodiment is performed (S12). The specific description of calculating the image write timing is given in the description of the second embodiment.

When the tab is located on the trailing edge of the sheet, conveyance control is provided in such a way as to keep constant the interval between the trailing edge of a tab-containing sheet and the leading edge of the succeeding sheet. If the tab is located at the leading edge of the sheet, conveyance control is provided in such a way as to keep constant the interval between the trailing edge of the sheet preceding the tab-containing sheet and the leading edge of the tab-containing sheet.

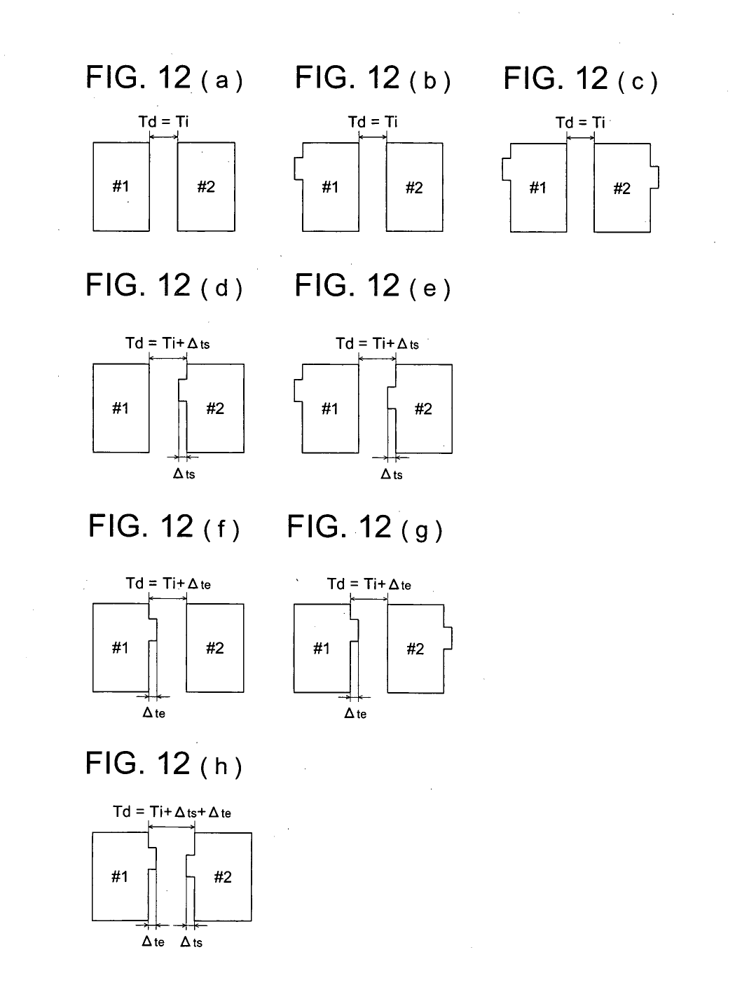

FIG. 12(a) through 12(h) are explanatory diagrams showing the position of the tabs of two sheets fed in the sheet conveyance direction, and the concept of control of intervals between sheets.

In FIG. 12(a) through 12(h), #1 (sheet #1) denotes a sheet being fed ahead of the other (a preceding sheet), and #2 (sheet #2) indicates a sheet succeeding the #1 (a succeeding sheet). Td shows the interval between sheets, Ti the interval between two sheets being fed where both of them have no tab, and Δts the length of the tab at the leading edge of the sheet #2 in the conveyance direction Δte the trailing edge of the sheet #1 in the conveyance direction.

As will be described later, when the sheet #2 has been determined in S10 to have no tab, and the sheet #1 has also been determined to have no tab, conveyance control is provided in such a way that the interval Td between the sheets #1 and #2 will be Ti, as shown in FIG. 12(a).

When the sheet #2 has been determined in S10 in FIG. 3 to have no tab, and the tab of the sheet #1 is present at the leading edge in the sheet conveyance direction, conveyance control is provided in such a way that the interval Td between the sheets #1 and #2 will be Ti, as shown in FIG. 12(b).

When the sheet #2 has been determined in S10 to have a tab, the tab of the sheet #2 is present at the trailing edge in the sheet conveyance direction, and the tab of the sheet #1 is present at the leading edge in the sheet conveyance direction, then conveyance control is provided in such a way that the interval Td between the sheets #1 and #2 will be Ti, as shown in FIG. 12(c).

Further, when the sheet #2 has been determined in S10 to have a tab, the tab of the sheet #2 is present at the leading edge in the sheet conveyance direction, and the sheet #1 has no tab or its tab is present at the leading edge in the sheet conveyance direction, then conveyance control is provided in such a way that the interval Td between the sheets #1 and #2 will be Ti+Δts, as shown in FIGS. 12(d) and 12(e).

When the sheet #2 has been determined in S10 to have no tab, and the tab of the sheet #1 is present at the trailing edge in the sheet conveyance direction, then conveyance control is provided in such a way that the interval Td between the sheets #1 and #2 will be Ti+Δte, as shown in FIG. 12(f).

When the sheet #2 has been determined in S10 to have a tab, the tab of the sheet #2 is present at the trailing edge in the sheet conveyance direction, and the tab of the sheet #1 is also present at the trailing edge in the sheet conveyance direction, then conveyance control is provided in such a way that the interval Td between the sheets #1 and #2 will be Ti+Δte, as shown in FIG. 12(g).

When the sheet #2 has been determined in S10 to have a tab, the tab of the sheet #2 is present at the leading edge in the sheet conveyance direction, and the tab of the sheet #1 is present at the trailing edge in the sheet conveyance direction, then conveyance control is provided in such a way that the interval Td between the sheets #1 and #2 will be Ti+Δts+Δte, as shown in FIG. 12(h).

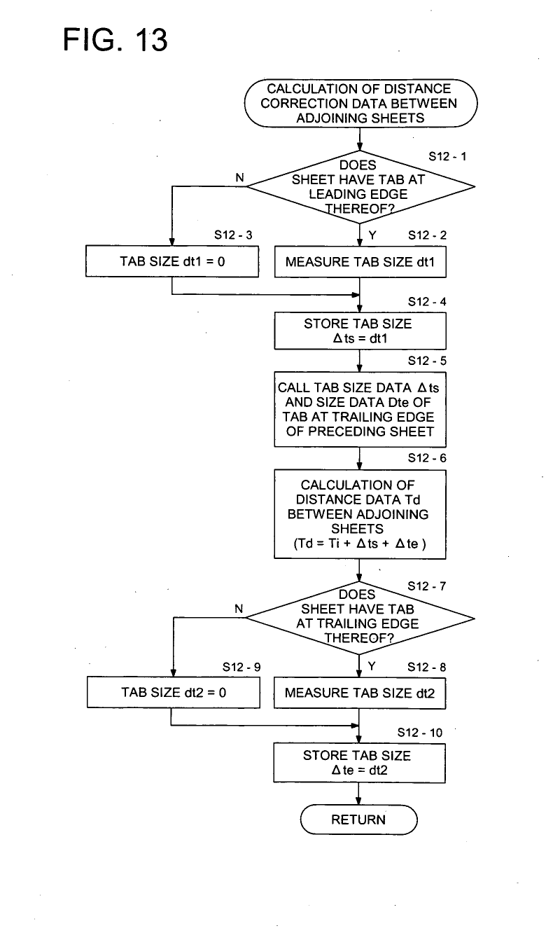

The following describes the details of the sheet interval correction data calculation in the conveyance control carried out in S12 of FIG. 3, with reference to the flowchart given in FIG. 13.

In the flowchart given in FIG. 13, a check is made to see if a tab is located at the leading edge of the sheet #2 (S12-1).

If it has been determined that a tab is located at the leading edge of the sheet #2 (Y in S12-1), the length of the tab of the sheet #2 in the sheet conveyance direction is measured by the tab detection sensor 81. The result of the measurement is assumed as the tab size dt1 at the leading edge (S12-2). If it has been determined that there is no at the leading edge of the sheet #2 (N in S12-1), the tab size dt1 at the leading edge is assumed as 0 (S12-3).

Then dt1 is stored as tab size data Δts at the leading edge (S12-4). Further, the Δts stored in (S12-4) and the tab size data Δte at the trailing edge as the length of the tab of the sheet #1 in the conveyance direction are called out, and the sheet interval data Td=Ti+Δts+Δte is calculated (S12-6).

Then a check is made to see if a tab is located at the trailing edge of the sheet #2 (S12-7). If it has been determined that a tab is located at the trailing edge of the sheet #2 (Y in S12-7), then the length of the tab of the sheet #2 in the sheet conveyance direction is measured by the tab detection sensor 81. The result of the measurement is assumed as the tab size dt2 at the leading edge (S12-8). If it has been determined that there is no at the trailing edge of the sheet #2 (N in S12-7), the tab size dt2 at the trailing edge is assumed as 0 (S12-9). Then dt2 is stored as tab size data Δte at the trailing edge (S12-10).

In the measurement of the aforementioned tab size dt1 at the leading edge (S12-2) and the tab size dt2 at the trailing edge (S12-8), reference has been made to the embodiment wherein the tab size of the sheet is detected on a real-time basis by the tab detection sensor 81 and the sheet-to-sheet correction is made. It is also possible to make such arrangements that the data of each tab sizes (dt1 and dt2) is inputted from the information input section (operation section 111) to use the data stored in the storage means (memory and register).

In this case, “read the tab size dt1 at the leading edge from the memory” in the S12-2, and “read the tab size dt2 at the trailing edge from the memory” in S12-8.

Such conveyance control removes the possibility of collision between a tab-containing sheet and a sheet preceding or succeeding the same, even when sheets are conveyed by reducing the interval between sheets in order to improve productivity, and eliminates the need of providing a margin of safety in sheet-to-sheet intervals.

To the sheet that is judged as being a sheet without a tab (S11 of FIG. 3) and conveyed by normal conveyance control (S13), normal image formation is carried out (S16), and then the sheet is ejected to the designated tray 71 (S19).

When the sheet fed by the feeding section 30 is judged as being the specified sheet with a tab (a sheet with a tab at the specified position and in the specified direction) (Y in S14) as a result of detection of tab position and direction for a sheet with a tab (S9), then whether or not the settings have been made to execute image formation onto the tab will be checked (S15).

If the settings have been made to execute image formation onto the tab (Y in S15), image formation is conducted on the overall surface area, including the tab, of the sheet with a tab (S17), and then the sheet will be ejected to the designated tray 71 (S19) If no settings have been made to execute image formation onto the tab (N in S15), then image formation is conducted on the surface area, excluding the tab, of the sheet with a tab (S18), and then the sheet will be ejected to the designated tray 71 (S19).

Each of the above operations, such as start feeding sheet (S8), detection of a sheet with a tab (S9), conveyance control (S13 and S14), image formation (S16, S17, and S18), and sheet ejection (S19), will be repeated until the last page (S20 to S8).

When the sheet fed by the feeding section 30 is judged as not being the specified sheet with a tab (a sheet with a tab at the specified position and in the specified direction) (Y in S14) as a result of detection of tab position and direction for a sheet with a tab (S9), then the control section 101 activates an alarm (S21) to notify that the sheet with a tab that has been specified does not agree with the sheet with a tab that has actually been fed, and temporarily stops the operation of the image forming apparatus (S22).

Here, the disagreement warning alarm can be the alarm display on the display section 112 by the control 101, outputs of buzzer sounds not shown in the drawing, outputs of voice messages also not shown in the drawing, or simultaneous use of the above.

As a result, users are able to clearly know without delay that the fed sheets are not of the specified type when using various types of sheets with tabs. This will then allow users to clearly know without delay even when the settings made with the operation section 111 were incorrect although the sheets with tabs in the paper feed cassette are correctly stacked when using various types of sheets with tabs.

Note that in the present embodiment, the control section 101 refers to various types of information, including the content of images to be formed inputted by the operation section 111 and the result of detection by the tab detection sensor 81, and the image processing section 120 processes images so that the writing section 40 forms images onto the tab part of a sheet with a tab. Also in the present embodiment, the images to be formed onto the tab part are displayed in the display section 112 beforehand. For the above reasons, accurate image formation onto the sheet including the tab part can be carried out.

The tab detection in the aforementioned operation and sheet conveyance control by the control section 101 in response to this tab detection are preferred to be carried out as described in any one of the following (a) through (p).

(a) After the sheet has been fed, the end of the tab in the feed direction is detected by the tab detection sensor 81. Based on the result of this detection, sheet conveyance is controlled in such a way as to keep constant the interval between the trailing edge of the sheet in the sheet conveyance direction and the leading edge of the succeeding sheet in the sheet conveyance direction.

(b) After the sheet has been fed, the end of the tab in the feed direction is detected by the tab detection sensor 81. Further, the tab detection sensor 81 checks whether this tab is located at the leading edge or trailing edge in the sheet conveyance direction. Based on the result of this detection, sheet conveyance is controlled in such a way as to keep constant the interval between the trailing edge of the sheet in the sheet conveyance direction and the leading edge of the succeeding sheet in the sheet conveyance direction.

(c) After the sheet has been fed, the end of the tab in the feed direction is detected by the tab detection sensor 81. Further, the tab detection sensor 81 detects the position of the tab in the direction orthogonal to the sheet conveyance direction. Based on the result of this detection, sheet conveyance is controlled in such a way as to keep constant the interval between the trailing edge of the sheet in the sheet conveyance direction and the leading edge of the succeeding sheet in the sheet conveyance direction.

(d) After the sheet has been fed, the end of the tab in the feed direction is detected by the tab detection sensor 81. Further, the tab detection sensor 81 checks whether this tab is located at the leading edge or trailing edge in the sheet conveyance direction. The tab detection sensor 81 detects the position of the tab in the direction orthogonal to the sheet conveyance direction. Based on the result of this detection, sheet conveyance is controlled in such a way as to keep constant the interval between the trailing edge of the sheet in the sheet conveyance direction and the leading edge of the succeeding sheet in the sheet conveyance direction.

(e) After the sheet has been fed, the end of the tab in the feed direction is detected by the tab detection sensor 81. Based on the result of this detection, sheet conveyance is controlled in such a way as to keep constant the interval between the trailing edge of the sheet in the sheet conveyance direction and the leading edge of the succeeding sheet in the sheet conveyance direction, whereby an image is formed on the tab by the image forming section.

(f) After the sheet has been fed, the end of the tab in the feed direction is detected by the tab detection sensor 81. Further, the tab detection sensor 81 checks whether this tab is located at the leading edge or trailing edge in the sheet conveyance direction. Based on the result of this detection, sheet conveyance is controlled in such a way as to keep constant the interval between the trailing edge of the sheet in the sheet conveyance direction and the leading edge of the succeeding sheet in the sheet conveyance direction, whereby an image is formed on the tab by the image forming section.

(g) After the sheet has been fed, the end of the tab in the feed direction is detected by the tab detection sensor 81. Further, the tab detection sensor 81 detects the position of the tab in the direction orthogonal to the sheet conveyance direction. Based on the result of this detection, sheet conveyance is controlled in such a way as to keep constant the interval between the trailing edge of the sheet in the sheet conveyance direction and the leading edge of the succeeding sheet in the sheet conveyance direction, whereby an image is formed on the tab by the image forming section.

(h) After the sheet has been fed, the end of the tab in the feed direction is detected by the tab detection sensor 81. Further, the tab detection sensor 81 checks whether this tab is located at the leading edge or trailing edge in the sheet conveyance direction. The tab detection sensor 81 detects the position of the tab in the direction orthogonal to the sheet conveyance direction. Based on the result of this detection, sheet conveyance is controlled in such a way as to keep constant the interval between the trailing edge of the sheet in the sheet conveyance direction and the leading edge of the succeeding sheet in the sheet conveyance direction, whereby an image is formed on the tab by the image forming section.

(i) After the sheet has been fed, the end of the tab in the feed direction is detected by the tab detection sensor 81. Tab information is inputted from the information input section (operation section 111). Based on the result of detection and input information, sheet conveyance is controlled in such a way as to keep constant the interval between the trailing edge of the sheet in the sheet conveyance direction and the leading edge of the succeeding sheet in the sheet conveyance direction.

(j) After the sheet has been fed, the end of the tab in the feed direction is detected by the tab detection sensor 81. Further, the tab detection sensor 81 checks whether this tab is located at the leading edge or trailing edge in the sheet conveyance direction. Tab information is inputted from the information input section (operation section 111). Based on the result of detection and input information, sheet conveyance is controlled in such a way as to keep constant the interval between the trailing edge of the sheet in the sheet conveyance direction and the leading edge of the succeeding sheet in the sheet conveyance direction.

(k) After the sheet has been fed, the end of the tab in the feed direction is detected by the tab detection sensor 81. The tab detection sensor 81 detects the position of the tab in the direction orthogonal to the sheet conveyance direction. Tab information is inputted from the information input section (operation section 111). Based on the result of detection and input information, sheet conveyance is controlled in such a way as to keep constant the interval between the trailing edge of the sheet in the sheet conveyance direction and the leading edge of the succeeding sheet in the sheet conveyance direction.

(1) After the sheet has been fed, the end of the tab in the feed direction is detected by the tab detection sensor 81. Further, the tab detection sensor 81 checks whether this tab is located at the leading edge or trailing edge in the sheet conveyance direction. The tab detection sensor 81 detects the position of the tab in the direction orthogonal to the sheet conveyance direction. Tab information is inputted from the information input section (operation section 111). Based on the result of detection and input information, sheet conveyance is controlled in such a way as to keep constant the interval between the trailing edge of the sheet in the sheet conveyance direction and the leading edge of the succeeding sheet in the sheet conveyance direction.

(m) After the sheet has been fed, the end of the tab in the feed direction is detected by the tab detection sensor 81. Tab information is inputted from the information input section (operation section 111). Based on the result of detection and input information, sheet conveyance is controlled in such a way as to keep constant the interval between the trailing edge of the sheet in the sheet conveyance direction and the leading edge of the succeeding sheet in the sheet conveyance direction, whereby an image is formed on the tab by the image forming section.

(n) After the sheet has been fed, the end of the tab in the feed direction is detected by the tab detection sensor 81. Further, the tab detection sensor 81 checks whether this tab is located at the leading edge or trailing edge in the sheet conveyance direction. Tab information is inputted from the information input section (operation section 111). Based on the result of detection and input information, sheet conveyance is controlled in such a way as to keep constant the interval between the trailing edge of the sheet in the sheet conveyance direction and the leading edge of the succeeding sheet in the sheet conveyance direction, whereby an image is formed on the tab by the image forming section.

(o) After the sheet has been fed, the end of the tab in the feed direction is detected by the tab detection sensor 81. The tab detection sensor 81 detects the position of the tab in the direction orthogonal to the sheet conveyance direction. Tab information is inputted from the information input section (operation section 111). Based on the result of detection and input information, sheet conveyance is controlled in such a way as to keep constant the interval between the trailing edge of the sheet in the sheet conveyance direction and the leading edge of the succeeding sheet in the sheet conveyance direction, whereby an image is formed on the tab by the image forming section.

(p) After the sheet has been fed, the end of the tab in the feed direction is detected by the tab detection sensor 81. Further, the tab detection sensor 81 checks whether this tab is located at the leading edge or trailing edge in the sheet conveyance direction. The tab detection sensor 81 detects the position of the tab in the direction orthogonal to the sheet conveyance direction. Tab information is inputted from the information input section (operation section 111). Based on the result of detection and input information, sheet conveyance is controlled in such a way as to keep constant the interval between the trailing edge of the sheet in the sheet conveyance direction and the leading edge of the succeeding sheet in the sheet conveyance direction, whereby an image is formed on the tab by the image forming section.

The tab information input and tab detection in the aforementioned operation, and image formation operation control in response to this information input and tab detection are preferred to be carried out as described in any one of the following (A) through (L).

(A) When the tab information inputted into the operation section 111 fails to agree with the tab position detected by the tab detection sensor 81, control is provided in such a way as to stop the operation of image formation.

(B) When the tab information inputted into the operation section 111 fails to agree with the tab position, detected by the tab detection sensor 81, of the sheet fed by the feeding section, control is provided in such a way as to stop the operation of image formation.

(C) When the tab information inputted into the operation section 111 fails to agree with the tab position, detected by the tab detection sensor 81, of the sheet fed by the feeding section before formation of an image, control is provided in such a way as to stop the operation of image formation.

(D) When the tab information inputted into the operation section 111 fails to agree with the tab position, detected by the tab detection sensor 81, of the sheet fed by the feeding section, before formation of an image on each side in the step of both-side image formation, control is provided in such a way as to stop the operation of image formation.

(E) When the tab information inputted into the operation section 111 fails to agree with the tab position, detected by the tab detection sensor 81, in the direction orthogonal to the sheet conveyance direction, control is provided in such a way as to stop the operation of image formation.

(F). When the tab information inputted into the operation section 111 fails to agree with the tab position, detected by the tab detection sensor 81, of the sheet fed by the feeding section, in the direction orthogonal to the sheet conveyance direction, control is provided in such a way as to stop the operation of image formation.

(G) When the tab information inputted into the operation section 111 fails to agree with the tab position, detected by the tab detection sensor 81, of the sheet fed by the feeding section, in the direction orthogonal to the sheet conveyance direction before formation of an image, control is provided in such a way as to stop the operation of image formation.

(H) When the tab information inputted into the operation section 111 fails to agree with the tab position, detected by the tab detection sensor 81, of the sheet fed by the feeding section, in the direction orthogonal to the sheet conveyance direction before formation of an image on each side in the step of both-side image formation, control is provided in such a way as to stop the operation of image formation.

(I) When the tab information inputted into the operation section 111 fails to agree with the tab position, detected by the tab detection sensor 81, in the sheet conveyance direction, control is provided in such a way as to stop the operation of image formation.

(J) When the tab information inputted into the operation section 111 fails to agree with the tab position, detected by the tab detection sensor 81, of the sheet fed by the feeding section, in the sheet conveyance direction, control is provided in such a way as to stop the operation of image formation.

(K) When the tab information inputted into the operation section 111 fails to agree with the tab position, detected by the tab detection sensor 81, of the sheet fed by the feeding section, in the sheet conveyance direction before formation of an image, control is provided in such a way as to stop the operation of image formation.

(L) When the tab information inputted into the operation section 111 fails to agree with the tab position, detected by the tab detection sensor 81, of the sheet fed by the feeding section, in the sheet conveyance direction before formation of an image on each side in the step of both-side image formation, control is provided in such a way as to stop the operation of image formation.

The aforementioned configuration and operation provide an image forming apparatus that allows an image to be formed on one side or both sides, including the tab of a tab-containing sheet, using various types of tab-containing sheets, without complicated setting operations, wherein a tab-containing sheet at a desired position can be inserted into a desired page position.

Further, the aforementioned configuration and operation ensure the maximum use of productivity when an image is to be formed on one side or both sides, including the tab of a tab-containing sheet, using various types of tab-containing sheets, without complicated setting operations.

### Second Embodiment

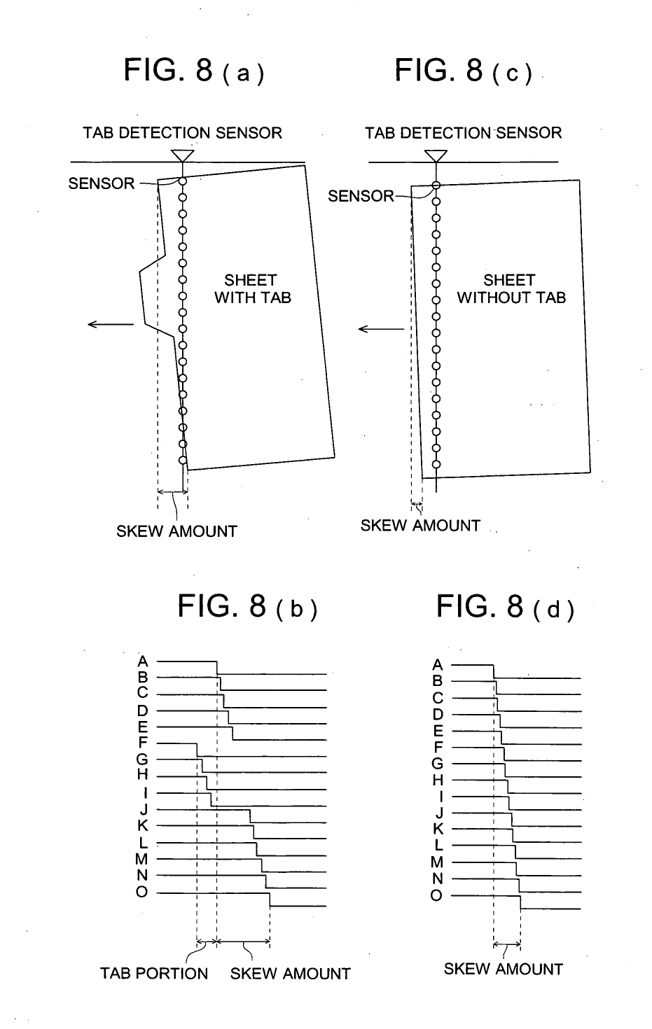

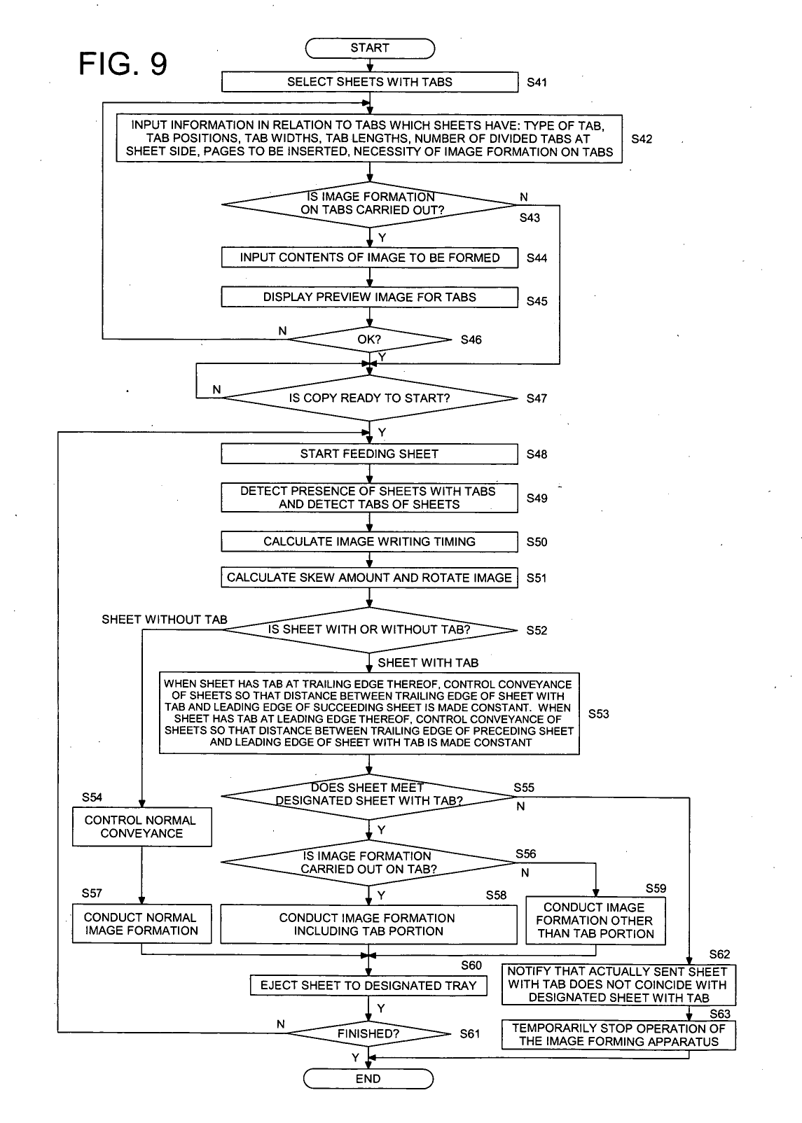

FIGS. 8(a) to 8(d) are explanatory drawings that illustrate operations in the second embodiment of the present invention. Also, FIG. 9 is a flowchart illustrating operation in the second embodiment of the present invention, and the operations are basically the same as that of the flowchart in FIG. 3. The redundant explanations on the common items will be omitted, and only differences will be described.

Here, the control section 101 is able to detect based on the result of detection provided by the tab detection sensor 81 as shown in FIG. 8(b) that, as a result of tab positions and directions detection (S49), the sheet with a tab fed by the feeding section 30 is inclined as shown in FIG. 8(a).

Similarly, the control section 101 is able to detect based on the result of detection provided by the tab detection sensor 81 as shown in FIG. 8(d) that, as a result of tab positions and directions detection (S49 in FIG. 9), the sheet with a tab fed by the feeding section 30 is inclined as shown in FIG. 8(c).

As described above, the control section 101 processes calculation for correction of image write timing, based on the tab position detected by the tab detection sensor 81 and the result of detecting the size (S50 in FIG. 9), and calculates the inclination angle of the sheet by referencing the result of detecting the sheet skew in the next step, whereby the image to be formed is rotated on the image memory in response to the inclination angle (S51).

In this manner, images are formed with no inclination onto sheets with tabs or sheets without tabs.

Also, depending on the position of the tab or direction of the inclination, it is possible that image formation cannot be carried out onto the tab due to an inclination that is too large if no image rotation processing, to respond to inclination of the sheet, is executed. With the inclination calculation and image rotation processing using the result of detection provided by the tab detection sensor 81 of the present embodiment, however, it is possible to conduct accurate image formation onto the tab in addition to image formation onto the area other than the tab even when a sheet is fed at an angle. Also, since the result of detection by the tab detection sensor 81 is used in this case, no dedicated inclination detection sensors are required, and also no loads are generated to be imposed on the image formation apparatus.

Furthermore, by executing conveyance control in which the distance between the trailing edge of the preceding sheet and the leading edge of the succeeding sheet is kept constant (S53 (equivalent to S12 in FIG. 3)), even though sheets may be fed at an angle, a sheet with a tab will not collide with a preceding or succeeding sheet even when intervals are shortened between the sheets for improved productivity, and thus no excess room will be necessary between the sheets. As a result, with the aforementioned configurations and operations, image formation can be conducted while maximizing its productivity when forming images on one or both sides of sheets with tabs with the tab included as a target area for image formation without making complicated settings for various types of sheets with tabs.

The “conveyance control for keeping constant the interval between the trailing edge of a sheet and the leading edge of the succeeding sheet” in S53 of FIG. 9 denotes conveyance control for keeping constant the interval between the trailing edge of the tab-containing sheet and the leading edge of the succeeding sheet, if the tab is located at the trailing edge of the sheet.

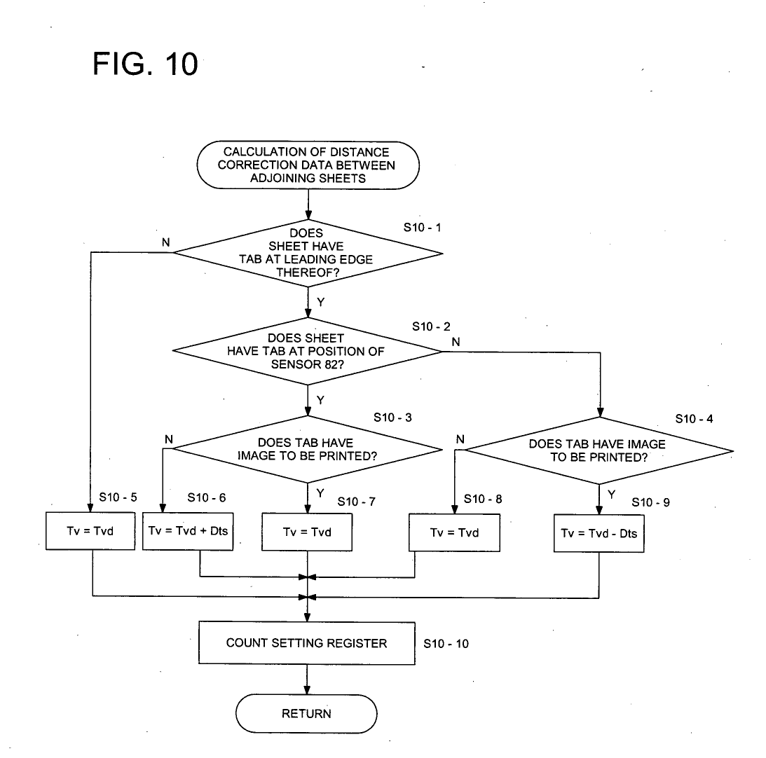

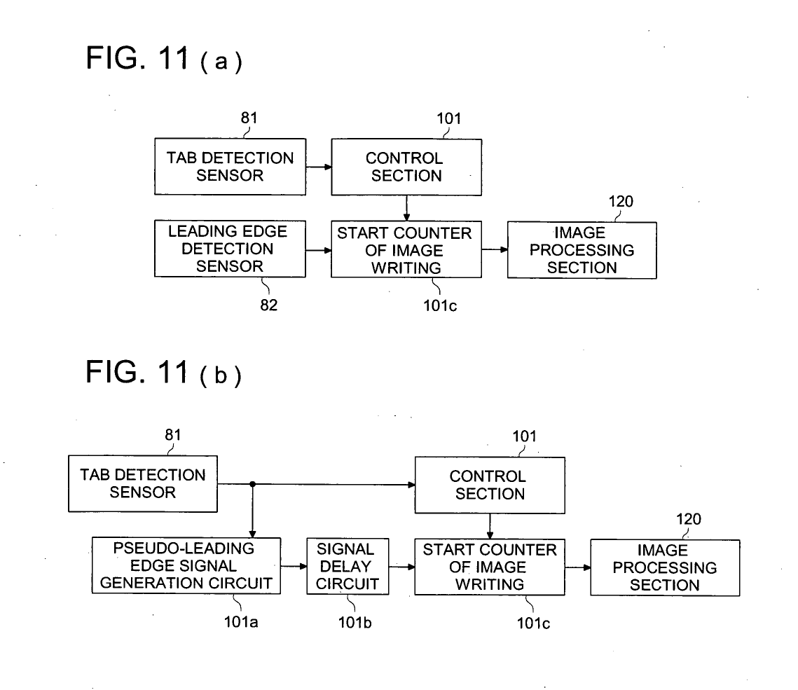

FIG. 10 shows the details of the procedures of image write timing control (S50 in FIG. 9) in the aforementioned flowchart. Image write timing control is represented in the function block diagrams of the FIGS. 11(a) and 11(b).

In FIG. 11(a), the control section 101 having received the result of detection by the tab detection sensor 81 corrects the preadjusted image write timing data Tvd, according to the correction data Δts of the tab size calculated from the result of tab detection. Then the corrected image write timing Tv is set on the count setting register of the image write start counter 10c.

Using the detection signal of the leading edge detection sensor 82 as a trigger, the image write start counter 101c counts up to the timing date Tv to determine the image write start timing. The image write start signal is then transmitted to the image processing section 120, whereby image writing starts.

When the leading edge detection sensor 82 is not used, the control section 101 in response to the result of detection by the tab detection sensor 81 sets the corrected image write timing data Tv on the count setting register of the image write start counter 10c, as described above with reference to FIG. 11(b).

Based on the detection signal of the leading edge detection sensor 82, the pseudo-leading edge signal generation circuit 101a generates a pseudo-leading edge signal, which is delayed a predetermined time by the signal delay circuit 10b. The delayed pseudo-leading edge signal is used as a trigger to cause the image write start counter 101c to count up to the timing data Tv. Thus, the image write start timing is determined and image write start timing signal is transmitted to the image processing section 120, whereby image writing starts.

The time delayed by the signal delay circuit 101b is equivalent to the time required for the sheet to be conveyed over the distance between the position of the tab detection sensor 81 and the position where the leading edge detection sensor 82 is assumed to be located.

In FIG. 10, based on the result of detection by the tab detection sensor 81, the control section 101 checks if the position of the tab of the sheet in the sheet conveyance direction is located on the side of the leading edge (S10-1). If not (N in S10-1), Tv=Tvd is assumed and normal control is provided (S10-5).

If the tab is located at the leading edge as a result of detection by the tab detection sensor 81 (Y in S10-1), the control section 101 determines that the tab is located at the position of the leading edge detection sensor 82 (image write start sensor) (Y in S10-2) If no tab is found at the position of the leading edge detection sensor 82 (image write start sensor) (N in S10-2), a check is made to see if an image is formed (printed) on the tab or not (S10-4).

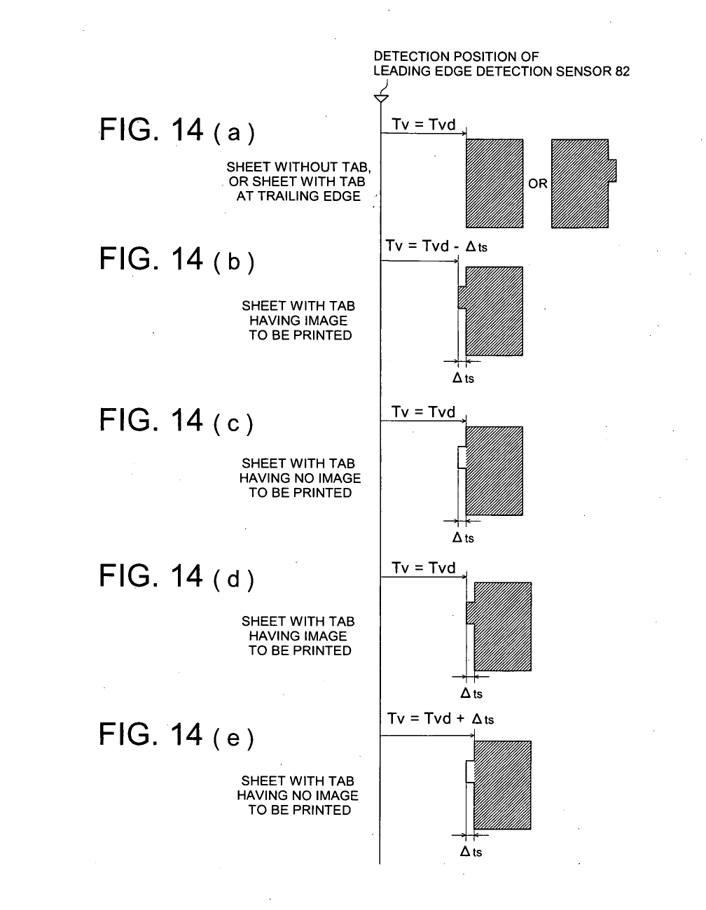

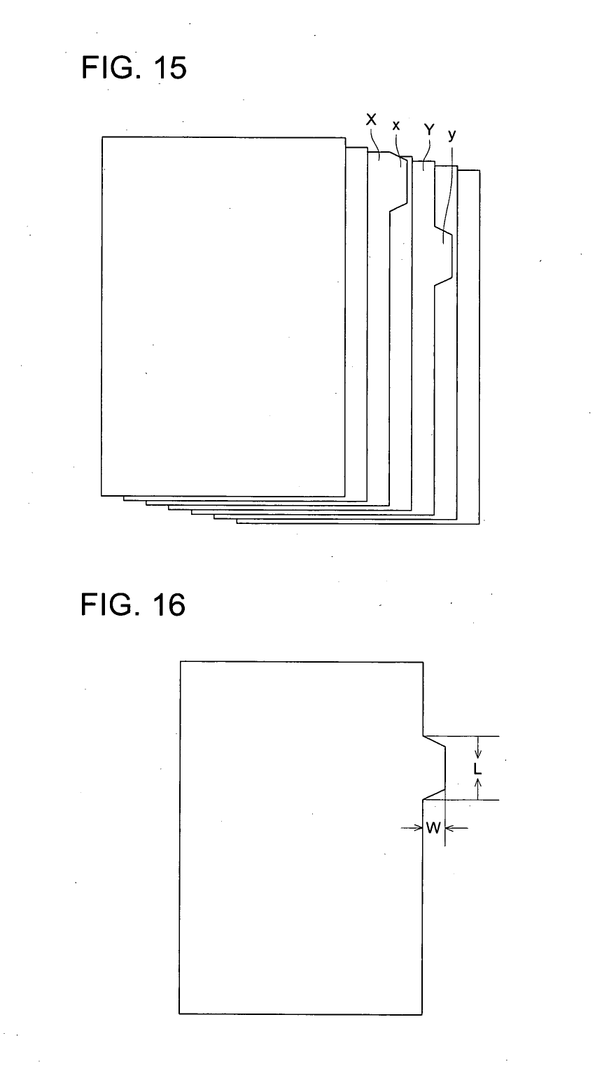

If no tab is found at the leading edge detection sensor 82 (N in S10-2) and an image is to be formed on the tab (Y in S10-4), the control section 101 assumes Tv=Tvd−Δts and corrects the tab portion (S10-9). To put it another way, in this case, preadjusted image write start timing data Tvd is corrected by the tab length Δts in the sheet conveyance direction, as shown in FIG. 14(b), and the timing data Tv (data to be set on the count setting register of the image write start counter 10c) is set to Tvd−Δts.

If no image is formed on the tab (N in S10-4), Tv Tvd is assumed, as shown in FIG. 14(c), and the control section 101 does not correct the tab portion (S10-8).

If a tab is present at the position of the leading edge detection sensor 82 (Y in S10-2) and no image is formed on the tab (N in S10-3), the control section 101 corrects the tab portion (S10-6). To put it another way, in this case, Tv is corrected by the tab length Δts in the sheet conveyance direction, as shown in FIG. 14(e), and the timing data Tv (data to be set on the count setting register of the image write start counter 10c) is set to Tvd+Δts.

When an image is formed on the tab (Y in S10-3), the control section 101 assumes Tv=Tvd, as shown in FIG. 14(d), and does not correct the tab portion (S10-7). The control section 101 sets the data Tv on the count setting register of the image write start counter (S10-10) and the image write start counter 101c performs predetermined timing adjustment. Then the image write start signal is sent to the image processing section 120.

For the configuration shown in FIG. 11(b), the signal formed by delaying of the pseudo-leading edge signal generated as a result of detection by the tab detection sensor 81 should be used on behalf of the result of detecting the leading edge of the sheet.

The image write start timing calculation and control in conformity to the tab in the aforementioned operation are preferred to be carried out as described in any one of the following (1) through (7).

(1) When an image can be formed on the tab, image formation timing is controlled based on the result of detection by the tab detection sensor 81 and the input information on whether the tab is located at the leading edge or trailing edge of the sheet.

(2) When an image can be formed on the tab, image formation timing is controlled based on: the tab position, detected by the tab detection sensor 81, in the direction orthogonal to the sheet conveyance direction, and the input information on whether the tab is located at the leading edge or trailing edge of the sheet.

(3a) When an image can be formed on the tab, image formation timing is controlled based on: the result of detection on whether the tab is located on the leading edge or trailing edge, and the input information on whether the tab is located at the leading edge or trailing edge of the sheet.

(3b) When an image can be formed on the tab, image formation timing is controlled based on: the detected tab position in the direction orthogonal to the sheet conveyance direction, the result of detection on whether the tab is located on the leading edge or trailing edge, and the input information on whether the tab is located at the leading edge or trailing edge of the sheet.

(4a) When an image can be formed on the tab, image formation timing is controlled, in such a way as to form an image on both sides, including the tab of a tab-containing sheet, based on: the result of detection by the tab detection sensor 81, and the input information on whether the tab is located at the leading edge or trailing edge of the sheet.

(4b) When an image can be formed on the tab, image formation timing is controlled, in such a way as to form an image on both sides, including the tab of a tab-containing sheet, based on: the tab position, detected by the tab detection sensor 81, in the direction orthogonal to the sheet conveyance direction, and the input information on whether the tab is located at the leading edge or trailing edge of the sheet.

(4c) When an image can be formed on the tab, image formation timing is controlled, in such a way as to form an image on both sides, including the tab of a tab-containing sheet, based on: the result of detection on whether the tab is located on the leading edge or trailing edge, and the input information on whether the tab is located at the leading edge or trailing edge of the sheet.

(4d) When an image can be formed on the tab, image formation timing is controlled, in such a way as to form an image on both sides, including the tab of a tab-containing sheet, based on: the detected tab position in the direction orthogonal to the sheet conveyance direction, the result of detection on whether the tab is located on the leading edge or trailing edge, and the input information on whether the tab is located at the leading edge or trailing edge of the sheet.

(5a) When an image can be formed on the tab, image formation write timing as image formation timing is controlled based on: the result of detection by the tab detection sensor 81, and the input information on whether the tab is located at the leading edge or trailing edge of the sheet.

(5b) When an image can be formed on the tab, image formation write timing as image formation timing is controlled based on: the tab position, detected by the tab detection sensor 81, in the direction orthogonal to the sheet conveyance direction, and the input information on whether the tab is located at the leading edge or trailing edge of the sheet.

(5c) When an image can be formed on the tab, image formation write timing as image formation timing is controlled based on: the result of detection on whether the tab is located on the leading edge or trailing edge, and the input information on whether the tab is located at the leading edge or trailing edge of the sheet.

(5d) When an image can be formed on the tab, image formation write timing as image formation timing is controlled based on: the detected tab position in the direction orthogonal to the sheet conveyance direction, the result of detection on whether the tab is located on the leading edge or trailing edge, and the input information on whether the tab is located at the leading edge or trailing edge of the sheet.

(5e) When an image can be formed on the tab, image formation write timing as image formation timing is controlled, in such a way as to form an image on both sides, including the tab of a tab-containing sheet, based on: the result of detection by the tab detection sensor 81, and the input information on whether the tab is located at the leading edge or trailing edge of the sheet.

(5f) When an image can be formed on the tab, image formation write timing as image formation timing is controlled, in such a way as to form an image on both sides, including the tab of a tab-containing sheet, based on: the tab position, detected by the tab detection sensor 81, in the direction orthogonal to the sheet conveyance direction, and the input information on whether the tab is located at the leading edge or trailing edge of the sheet.

(5g) When an image can be formed on the tab, image formation write timing as image formation timing is controlled, in such a way as to form an image on both sides, including the tab of a tab-containing sheet, based on: the result of detection on whether the tab is located on the leading edge or trailing edge, and the input information on whether the tab is located at the leading edge or trailing edge of the sheet.

(5h) When an image can be formed on the tab, image formation write timing as image formation timing is controlled, in such a way as to form an image on both sides, including the tab of a tab-containing sheet, based on: the detected tab position in the direction orthogonal to the sheet conveyance direction, the result of detection on whether the tab is located on the leading edge or trailing edge, and the input information on whether the tab is located at the leading edge or trailing edge of the sheet.

(6) When an image can be formed on the tab, various types of image formation timing are controlled, based not only on the results of various detections by the tab detecting section, but also on the input information from the operation section 111 on whether the tab is located at the leading edge or the trailing edge of the sheet.

(7) Various types of image formation timing are controlled, based on; the results of various detections, by the tab detection sensor 81, of the information consisting of at least one of the information items on the tab type, tab position, tab width, tab length, number of divided tabs, page to be inserted, necessity of image formation on the tab (formed side), and content of the image to be formed on the tab; and the input information on whether the tab is located at the leading edge or the trailing edge of the sheet.

### Other Embodiments

Although-operation of the image forming apparatus is stopped after a warning is issued if a sheet with a tab other than a specified type is fed in the first and second embodiments, it is also possible to execute control so as not to stop the image forming operation if no such stoppage is necessary.

For example, a modification is possible such as in the case in which if a sheet with a tab having a tab larger than the specified tab is fed but image forming operation to the tab is still executable with no problems, image formation operation will continue although a warning is issued. In the above case, it is desirable that image formation operation be stopped whether there is a possibility of images being formed outside the tab or image formation is definitely impossible.

Also, although the control section 101 first issues an alarm (S21 in FIG. 3, and S23 in FIG. 10) to notify that the sheet with a tab that is specified does not agree with the actually fed sheet with a tab, and temporarily stops the operation of the image forming apparatus (S22 in FIG. 3, and S23 in FIG. 10), control can be executed so as to stop the image forming operation without issuing an alarm.

1. An image forming apparatus comprising:
(a) a feeding section for feeding a sheet with a tab and a sheet without a tab;
(b) a tab detecting section for detecting an end portion in a sheet conveyance direction, of the tab on the sheet fed by the feeding section;
(c) a conveying and driving section for conveying the sheet fed by the feeding section; and
(d) a control section for controlling the conveying section so as to keep constant an interval between a trailing edge of a preceding sheet in the sheet conveyance direction and a leading edge of a succeeding sheet, based on a result detected by the tab detecting section.

2. The image forming apparatus of claim 1, wherein the tab detecting section detects whether the tab is located at a leading edge or a trailing edge of the sheet in the sheet conveyance direction.

3. The image forming apparatus of claim 1, wherein the tab detecting section detects a position of the tab in a direction orthogonal to the sheet conveyance direction.

4. The image forming apparatus of claim 1, further comprising an image forming section for forming an image on the tab.

5. The image forming apparatus of claim 1, further comprising an information input section to which information on the tab of the sheet with the tab is inputted, wherein the control section controls the conveying and driving section to keep constant the interval between the trailing edge of the preceding sheet in the sheet conveyance direction and the leading edge of the succeeding sheet, based on the result detected by the tab detecting section and the information on the tab.

6. An image forming apparatus comprising:
(a) an information input section to which information on a tab of a sheet with the tab is inputted;
(b) a feeding section for feeding the sheet with the tab and a sheet without a tab;
(c) a tab detecting section for detecting a position of the tab on the sheet with the tab;
(d) an image forming section for forming an image on the tab on the sheet with the tab; and
(e) a control section for controlling to stop an image forming operation, when an image is formed on the tab, and the information on the tab inputted into the information input section does not agree with a result detected by the tab detecting section.

7. The image forming apparatus of claim 6, wherein the tab detecting section detects the position of the tab of the sheet fed by the feeding section.

8. The image forming apparatus of claim 7, wherein the tab detecting section detects the position of the tab of the sheet before an image is formed on the sheet by the image forming section.

9. The image forming apparatus of claim 7, wherein the image forming section forms an image also on the other side of the sheet by circulating the sheet with an image which has been formed on one side thereof, and the tab detecting section detects the position of the tab of the sheet before formation of the image on each side of the sheet.

10. The image forming apparatus of claim 6, wherein the tab detecting section detects the position of the tab in the direction orthogonal to a sheet conveyance direction.

11. The image forming apparatus of claim 6, wherein the tab detecting section detects the position of the tab in a direction orthogonal to the sheet conveyance direction.

12. An image forming apparatus comprising:
(a) a feeding section for feeding a sheet with a tab and a sheet without a tab;
(b) a tab detecting section for detecting a position of the tab on the sheet with the tab;
(c) an image forming section for forming an image on the tab on the sheet with the tab; and
(d) a control section for controlling an image formation timing of the image forming section, based on a result detected by the tab detecting section and information on whether the tab is located at a leading edge or a trailing edge of the sheet in a sheet conveyance direction.

13. The image forming apparatus of claim 12, wherein the tab detecting section detects the position of the tab in the direction orthogonal to the sheet conveyance direction.

14. The image forming apparatus of claim 12, wherein the tab detecting section detects whether the tab is located at the leading edge or the trailing edge of the sheet in the sheet conveyance direction.

15. The image forming apparatus of claim 12, wherein the control section controls image formation timing in the image forming section so that an image is formed on each of both sides of the sheet including the tab of the sheet, based on a result detected by the tab detecting section and information on whether the tab is located at the leading edge or the trailing edge of the sheet.

16. The image forming apparatus of claim 12, wherein the image formation timing represents timing for writing an image on the sheet.

17. The image forming apparatus of claim 12, further comprising an information input section to which information on the tab of the sheet with the tab is inputted.

18. The image forming apparatus of claim 5, wherein the information on the tab of the sheet with the tab inputted into the information input section includes at least one of information on a tab type, a tab position, a tab width, a tab length, the number of divided tabs, a page to be inserted, necessity of image formation on the tab, and contents of the image to be formed on the tab.

19. The image forming apparatus of claim 6, wherein the information on the tab of the sheet with the tab inputted into the information input section includes at least one of information on a tab type, a tab position, a tab width, a tab length, the number of divided tabs, a page to be inserted, necessity of image formation on the tab, and contents of the image to be formed on the tab.

20. The image forming apparatus of claim 17, wherein the information on the tab of the sheet with the tab inputted into the information input section includes at least one of information on a tab type, a tab position, a tab width, a tab length, the number of divided tabs, a page to be inserted, necessity of image formation on the tab, and contents of the image to be formed on the tab.

21. The image forming apparatus of claim 1, wherein the tab detecting section comprises a plurality of detectors for detecting the position of the tab of the sheet fed by the feeding section before an image is formed on the sheet.

22. The image forming apparatus of claim 6, wherein the tab detecting section comprises a plurality of detectors for detecting the position of the tab of the sheet fed by the feeding section before an image is formed on the sheet.

23. The image forming apparatus of claim 12, wherein the tab detecting section comprises a plurality of detectors for detecting the position of the tab of the sheet fed by the feeding section before an image is formed on the sheet.

24. The image forming apparatus of claim 5, further comprising an alarm section for notifying an abnormal state, wherein the control section controls the alarm section to notify the abnormal state when the information on the tab inputted into the information input section does not agree with a result detected by the tab detecting section.

25. The image forming apparatus of claim 17, further comprising an alarm section for notifying an abnormal state, wherein the control section controls the alarm section to notify the abnormal state when the information on the tab inputted into the information input section does not agree with a result detected by the tab detecting section.

26. The image forming apparatus of claim 5, further comprising an alarm section for notifying an abnormal state, wherein the control section controls the alarm section to notify the abnormal state when the information on the tab inputted into the information input section does not agree with a result detected by the tab detecting section, and further controls to stop image formation operation when an image cannot be formed on the tab due to the disagreement.

27. The image forming apparatus of claim 6, further comprising an alarm section for notifying an abnormal state, wherein the control section controls the alarm section to notify the abnormal state when the information on the tab inputted into the information input section does not agree with a result detected by the tab detecting section, and further controls to stop image formation operation when an image cannot be formed on the tab due to the disagreement.

28. The image forming apparatus of claim 17, further comprising an alarm section for notifying an abnormal state, wherein the control section controls the alarm section to notify the abnormal state when the information on the tab inputted into the information input section does not agree with a result detected by the tab detecting section, and further-controls to stop image formation operation when an image cannot be formed on the tab due to the disagreement.

29. The image forming apparatus of claim 1, wherein the control section calculates an inclination of the sheet fed by the feeding section by referring to a result detected by a plurality of detectors of the tab detecting section, and corrects the information of an image to be formed by an image forming section according to the calculated inclination of the sheet.

30. The image forming apparatus of claim 6, wherein the control section calculates an inclination of the sheet fed by the feeding section by referring to a result detected by a plurality of detectors of the tab detecting section, and corrects the information of an image to be formed by the image forming section according to the calculated inclination of the sheet.

31. The image forming apparatus of claim 12, wherein the control section calculates an inclination of the sheet fed by the feeding section by referring to a result detected by a plurality of detectors of the tab detecting section, and corrects the information of an image to be formed by the image forming section according to the calculated inclination of the sheet.

32. The image forming apparatus of claim 29, wherein the control section corrects so that an image to be formed on a sheet has no inclination.
